(19) United States
(12) Patent Application Publication
(10) Pub. No.: US 2004/0215472 A1
(43) Pub. Date: Oct. 28, 2004

(54) System and method for the cross-platform transmission of messages

(76) Inventor: Harris Gleckman, Chappaqua, NY (US)

Correspondence Address: JOHN M. JOHNSON, CARTER LEDYARD & MILBURN, LLP, 2 WALL STREET, NEW YORK, NY, 10005, US

(21) Appl. No.: 10/421,610

(22) Filed: Apr. 22, 2003

(51) Int. Cl. G06F 17/60

(52) U.S. Cl. 705/1; 708/204

(57) ABSTRACT

Accordingly, the present invention transfers a message package from one communication system to another and re-directing it to an output site that shortens the time for ‘delivery’ of a message and transforming the unique recipient contact address from one communication system to the format in another. The present invention utilizes the flexibility of SGML, XML, HTML and similar codes and manages the large volume of micro-payments in an efficient manner. The originating message can be an e-mail, a fax, a letter, a voice message, message created in a private message system (e.g. air line reservation system) or other message type. The subject invention creates a standardized intermediary platform that links together the speed and near zero cost of an email with the diversity of input and output communications devices and an optimization routine for the selection of best available physical location for the final output process.

### FIELD OF THE INVENTION

The present invention relates to message delivery systems (such as electronic mail, fax, telephone calls, and paper mail delivery systems), and more specifically relates to a method to interconnect messages between separate message delivery systems.

### BACKGROUND OF THE INVENTION

A number of discrete message transmission systems have evolved over time. Currently the most frequently used sender-to-recipient message systems are postal letters, telephone calls, electronic mail, fax, and various internal private electronic message systems. Each of these message media has its own comparative advantage. To mention a few, telephones are ubiquitous and provide a re-assuring human voice; fax machines provide a way to transfer diagrams and laid out text with confidence that the recipient will see it exactly as it was sent; email is fast and encourages a highly informal drafting style; and letters have the feel of greater privacy and the pleasure of the ‘mail moment’ when opening the envelope.

Over the past few years, a number of technologies have been developed to allow one to craft message in one communication medium and have it distributed in another communication medium. For example, one can draft a letter on the computer, as if one were about to send it by email, but opt to have it transmitted and delivered as a fax. One can now draft and send an email, have it printed out looking like an email but delivered as a letter. These hybrid sender-to-recipient message systems seek to incorporate aspects of the strengths and benefits of the sending message system with strengths and benefits of a receiving message system.

The “sender email” to “recipient postal letter” hybrid system can illustrate some of the advantages of this form of a hybrid message system, as well as illustrate some of the limitations of the current versions of such email-to-postal-letter hybrid systems. Email is clearly an enhancement over a post letter in terms of speed of delivery, ease of preparing to send a ‘postal message’, lack of transmission charges for individual messages, and free confirmation of delivery. The benefit of a mail message is to enjoy the “mail moment”, the chance to ‘hold it in one’s hand”, to be able to read the message without a computer, to have a hardcopy for legal purposes, and to be able to retain the physical original mail without further effort. The benefits of the elimination of the physical transport of the message are, of course, greater for international mail. In general, the greater the distance between the sender and the recipient, the more the saving in delivery time and in the cost for the message service.

A regular mail letter takes one to four days for delivery. The letter needs to collected from a mail box, sorted for its destination, moved to a regional center, placed in a truck, train, or plane (or a combination of these) to arrive at another regional center, sorted again, and given to the final postal delivery person. For international commercial senders, the multi-day delivery of regular post mail is so unacceptable that private air courier letter services have become a regular vehicle for the transmission of even routine business mail.

Both the current postal system and the current private air courier system face high costs for collecting the individual small charges for each message. This generally requires an extensive system for manually determining the correct weight/distance changes, receiving small payments, making change, daily settling of teller balances and authorizing credit card transactions. To reduce these burdens on the postal users and the postal system, some postal services have begun to sell stamps over the Internet. In addition, corporations operate complex internal accounting systems to monitor the cost by sub-units of postal supplies and postal services.

The existing hybrid sender-to-recipient message systems are, however, largely bilateral and unidirectional. A technology, largely software-based, facilitates the transformation of a message from one specific communication medium to another specific communication medium. What does not exist is a universal communication system platform that facilitates hybrid communications between any one system of sender-to-recipient communication media and all other possible forms of such media.

The combination of benefits of associating one message-sending medium with a different receiving message medium often leads to an awkwardness in the appearance of the delivered message. As noted above, hybrid email to postal letter systems produce just a printed version of the sending email. Web-based systems for sending messages to postal recipient systems also produce a ‘letter’ that has all the rigidity of a web form message and little of the style of a normal letter. What does not exist is a method or a system that enhances the style and appearance of the final message through the full integration of generalized mark up languages, other design management software, and the flexibility of a browser. The current system cannot remove the rigid style of an email message and align it to the expected style of the recipient message system, taking full advantage of the special design characteristics of the recipient message system. An email message, for example, from the sender cannot yet arrive looking like a formal business letter and an appropriate multi-colored business logo off centered to the left.

In the existing hybrid message communication systems the sender specifies the address of the recipient as a postal address, a fax/telephone number, or an email address. With mass mailings some senders can create one email message that is replicated to specified categories of recipients in a database, extracting the unique postal address or fax number from the database records. This explicit designation of the recipient address by the sender or generic designation of recipient address from marketing databases limits the flexibility of hybrid mail as it fails to take good advantage of all other unique personal identifiers as potential addressees. These other unique personal identifiers such as frequent flyer numbers, employee identification numbers, and social security numbers can provide a way to transform these non-postal id numbers from their original unique designation function into an acceptable ‘address’ for a communication system.

While the marginal cost of an email is nearly zero, the cost of transmission of a telephone/fax message and a postal letter can vary inter alia with distance and the length of the message. Hybrid message communication systems need to account for costs incurred in the sending system and the costs incurred in the delivery system—both of which are likely to be very small individual quantities of money per message unit. In addition as more than one largely independent billing systems can be involved, current systems face significant disincentives to market acceptance for ‘extra’ charges for the cross-message platform function. The current invention integrates a module that manages the complexities of many large volume of micro-payments transactions without significant user charges.

It will be understood that the subject invention provides non-limiting advantages and uses that includes faster delivery of domestic and international mail at a lower cost, (of interest to national, foreign and private postal systems, bulk mailers, print shops and fulfillment houses) delivery of letters behind a security (fire) wall (of interest to travel reservation systems and business entities with consumer loyalty programs, e.g., frequent flyer or hotel members); print shops used as postal centers (of interest to commercial printers and consumer photocopy centers); the e-mailing of messages to airline passengers and real time passenger arrival information from airlines (of interest to air travel reservation systems and businesses with consumer loyalty programs, e.g., frequent flyer or hotel members); and e-mail messages transmitted through the use of a telephone (of interest to local and regional telephone companies as well as support services for the visually impaired).

Thus, in one embodiment of the functioning of the present invention, a message sender sends an email to the central email server at an airline/airline club/hotel chain with the recipient's unique membership number in the “subjectline” of the email message. The central email server would query the organization's unique membership database for the next scheduled contact with the passenger/club member for a given number of days/hours, redirect the message via email or an internal corporate communication network to the appropriate local site, and set up a notification to the organization's “front desk” regarding the member's incoming message. Were the Central email server to discover that the passenger/club member was not scheduled to be in touch with the organization within the specific period, the central email server would generate an email message to the original sender stating such. Passenger/hotel guest could have the option to read the message on a monitor or have it printed.

The current U.S. Postal Service electronic activities are quite limited. The U.S. Postal Service electronic activities (www.usps.com) are largely just the emulation of existing electronic business practices (e.g. Internet sales of stamps) or functions of traditional fulfillment houses. The U.S. Postal Service, for example, offers secure electronic banking services in competition with the secure electronic services of on-line banks. The U.S. Post Service also offers a mail fulfillment service, called NetMail, in which the U.S. Post Office undertakes to print and stuff mail for clients who wish to outsource this function. The U.S. Post Office accepts input for this fulfillment service over the Internet.

Other national postal systems such as those offered by China Postal Service and India Post, provide hybrid email to letter post services or webform to letter post services. Senders, particularly those wishing to transmit messages over long distances or where there is limited access to postal services, compose a web-based message or an email message that is printed and delivered close to the final destination. These bilateral hybrid systems are also uni-directional. The recipient cannot reply in the arriving message system and have their message transmitted in the sending message system or in another other system (e.g. a recipient of a postal letter cannot write a letter reply and have it delivered by email.)

While “e-postal” technology is generally known, as referenced in e Postal News, the technology discussed therein merely relates to, for example, digital security of on-line e-postal transactions and linking on-line web resident forms to e-mail transmissions, neither of which is the focus of the subject invention.

Some commercial hybrid message systems, such as Web ePost by International Data Post A/S, Denmark, are largely based on web-form technologies. A user logs onto the internet, selects a url address of a commercial postal service, and composes their message online, provides the designated address of the recipient in the delivery message system and makes payment arrangements thorough a credit card or other external secure payment system. Making the original message system web-based tends to limit the flexibility of the format of the message and types of messages styles and contents that can be transmitted. Graphic images such as those usually transmitted by postal mail or fax are not facilitated by web based systems; further the web-form input message does not permit the use of generalized markup languages that can enhance the appearance of the final output message.

Other commercial hybrid message systems, such as Mail2000 based in Bethesda Md. (www.mail2000.com), do permit direct message transmission to the commercial site, where the largely bulk messages are re-formatted into company-specific formats. This system is bilateral and uni-directional. What is not currently not available is an easy format standard for use of individual, small and medium-scale message senders that is flexible enough to support multiple output message systems and adaptable enough to use all forms of existing email attachments as components of the user's message package.

U.S. Pat. No. 4,797,832 issued to Axelrod, et al. discloses an apparatus for preparing a letter is provided, which includes printing structure, stationery item supplying structure and a computer. The computer is constructed and arranged for receiving a signal representative of letter data corresponding to information having a format. The information includes a plurality of parts. The computer includes structure for reformatting the letter data. The reformatted letter data includes a plurality of parts. And, each of the information parts corresponds to a different one of the data parts. The computer also includes structure for selecting at least one of the data parts, causing the supplying structure to supply the stationery item to the printing structure and causing the printing structure to print on the stationery item the information part corresponding to the selected data parts.

U.S. Pat. No. 5,742,932 issued to Levitsky discloses an invention that is a method of accounting for a transaction cost and currency exchange relative to customer accounts in a hybrid mail system. The method begins by establishing a data center, a first remote data entry point, and a second remote data entry point, which has mailpiece production means. The first remote data entry point, the second remote data entry point, and/or the data center may be co-located. A set of parameters which define a mailpiece, a unit cost where known for each parameter, a destination for the mailpiece, and a choice of debiting or crediting a customer account are determined at the first remote data entry point. The parameters and known costs point are transmitted to the data center and to the second remote data entry point. The mailpiece is produced at the second remote data entry point and a unit cost for each of the mailpiece production and delivery elements is calculated at the second remote data entry point and transmitted to the data center. A total unit cost of the transaction is calculated at the data center and then converted to a transaction cost by multiplying the total unit cost by a currency conversion factor. The transaction cost is then entered into customer account database, a transaction database, and transmitted to the first remote data entry point; additionally, a billing statement is generated by the data center in respect of the transaction and a similar statement can be generated by the first remote data entry point for the benefit of the transaction initiator.

But U.S. Pat. No. 5,742,932, unlike the present invention, is not concerned with any message transmission besides mail-to-mail. Hence, the '932 patent does not suggest nor contemplate “cross-platform” message transmission, as does the subject invention. Further, the '932 patent lacks a self standing costing module that can be resident at multiple locations, and also lacks a payment system that employs an internal corporate accounting system.

U.S. Pat. No. 5,805,810 issued to Maxwell teaches a method of generating mail objects from email messages. The method is performed by a computer system having at least one database containing identifiers for senders of email messages, identifiers for corresponding recipients of mail objects, and address information for both the senders and recipients. The method is broadly comprised steps of three steps: (1) receiving an email message from a sender; (2) locating in the database an identifier for the sender and an identifier for a recipient specified in the email message; and (3) generating a mail object from the email message using the address information in the database for the sender and for the recipient.

Unlike U.S. Pat. No. 5,805,810, the subject invention employs a standardized message package and a re-direction manager, as opposed to a database lookup or record keeping system. Furthermore, the '810 patent does not dynamically select the most appropriate center, but instead employs a generic receiving station approach.

U.S. Pat. No. 5,819,040 issued to Ogaki et al. discloses an image processing system has a scanner for reading image information of a sheet, on which a first instruction for transferring image information of an electronic document and image information of a paper document to an arbitrary program at a first terminal as a single transferred document and a second instruction for starting an arbitrary second terminal for creating the electronic document, together with the image information of the paper document, a function for starting the program at the second terminal to create the image information of the electronic document on the basis of the second instruction, and a function for transferring the image information of the paper document and the image information of the electronic document as a single transferred document to the first terminal on the basis of the first instruction.

In contrast to the present invention, U.S. Pat. No. 5,819,040 does not employ a message preparation system using an independently structured message format and xml or html codes for redesigning message output format; a payment system implementing an internal corporate accounting system and payment system for mail output services; a re-direction system; and an output system employing a dynamic link between the output sub-operator and the central system.

U.S. Pat. No. 6,023,345 issued to Bloomfield teaches a fax to E-mail system and related method are shown, whereby a hardcopy document is sent via a fax device to its recipient via electronic mail through a data network (such as the Internet), and is delivered in such a manner that it can be retrieved by the recipient at an E-mail device, in the ordinary course of retrieving the E-mail, and displayed on the screen of the E-mail device. The invention provides for and accomplishes the delivery of a document, which begins as a hardcopy, as an electronic file retrieved through E-mail recipient's terminal and displayed on the computer screen of the E-mail recipient's terminal. The system and method also provides for an interface device that connects to a conventional fax device for communicating E-mail addresses and routing hardcopy documents to the E-mail network. The invention provides a means for embedding the functions of the interface device into conventional fax devices. The system can also be used in cooperation with Internet Web service for reporting, accounting, information services, and user interaction.

U.S. Pat. No. 6,025,931 issued to Bloomfield discloses a fax to E-mail system and related method are shown, whereby a hardcopy document is sent via a fax device to its recipient via electronic mail through a data network (such as the Internet), and is delivered in such a manner that it can be retrieved by the recipient at an E-mail device, in the ordinary course of retrieving the E-mail, and displayed on the screen of the E-mail device. The invention provides for and accomplishes the delivery of a document, which begins as a hardcopy, as an electronic file retrieved through E-mail recipient's terminal and displayed on the computer screen of the E-mail recipient's terminal. The system and method also provides for an interface device that connects to a conventional fax device for communicating E-mail addresses and routing hardcopy documents to the E-mail network. The invention provides a means for embedding the functions of the interface device into conventional fax devices. The system can also be used in cooperation with Internet Web service for reporting, accounting, information services, and user interaction.

Unlike U.S. Pat. No. 6,025,931, the subject invention contemplates the use of both xml and html commands in the final e-mail message, and has both a document logging/record keeping system and a payment system.

U.S. Pat. No. 6,211,972 issued to Okutomi et al. teaches an electronic mail converting apparatus for facsimile that includes connections connecting to a facsimile, a public network, and a LAN. The connections may be internally changed according to the type of data or an instruction received. A converting device exists for converting data to e-mail data or vice versa, as required, wherein the converted data is transmitted to an instructed designation.

U.S. Pat. No. 6,366,827 issued to Krasuski et al. teaches a system for preparing mail items, the system comprising a general-purpose computer for preparing a document to be sent, a secure metering device connected to the general-purpose computer via a secure link so as to send it postage metering or “franking” information, a printer connected to the general-purpose computer so as to print both the document to be sent, and at least a destination address for the document and a postage imprint on an envelope that is to receive the document, and a folder/inserter connected both to the printer and to the general-purpose computer so as to receive and fold the printed document and so as to insert it into the corresponding franked envelope.

U.S. Patent Application No. 2001/0012120 filed by Yukikazu Mori discloses a network facsimile apparatus relaying electronic mail to a facsimile machine receives electronic mail via a local area network and the Internet and transmits facsimile data including facsimile image information and a facsimile data file through facsimile communications procedures via PSTN. The network facsimile apparatus analyzes the received E-mail to determine if it is relay transmission mail and if received relay transmission mail includes text contents, reads a telephone number of a destination facsimile machine from the received relay transmission mail, and converts the contents of the received electronic mail into facsimile image information when the received E-mail is a relay transmission mail and includes text contents and into a facsimile transfer data file when the received E-mail is relay transmission mail and includes non-text contents and transmits one of the facsimile image information and the facsimile transfer data file to the destination facsimile machine having the telephone number read from the received relay transmission mail.

Note that U.S. Patent Application No 2001/0012120, unlike the present invention, merely facilitates a communications infrastructure designed to avoid telephone charges. None of the essential modules of the subject invention are completely employed.

U.S. Patent Application No. 2001/0012378 filed by Dimitri Kanevsky et al. teaches about a communication system that transmits and receives combinations of paper mail and electronic mail. The system provides that a user can send an Internet message to post mail including the post mail address for delivery. The post mail office forwards the Internet message via e-mail to the Internet post office that is the closest to the addressee. This post office that is local to the addressee downloads this message, prints a hard copy on a paper, encloses it in an envelop and sends the hard copy to the addressee via usual local mail. The communication system also provides that a user send paper mail to the post office. The post office scans the paper mail and forwards the scanned information data either to the addressee directly via Internet or via a post office that is local to the addressee.

However, U.S. Patent Application No. 2001/0012378 does not have, as does the subject invention, a message preparation system with an independently structured message format or xml and html codes for output re-design; a payment system with an internal corporate accounting system or adaptability for a mail output service; a re-direct manager system; or an output system that employs dynamic links between output sub-operators and the central system.

U.S. Patent Application No. 2001/0019359 filed by Kenneth A. Parulski et al. discloses an electronic still camera for capturing images to be transferred to at least one e-mail address is disclosed. The electronic still camera includes an image sensor for capturing a plurality of images of scenes and for producing image signals representative of the corresponding scenes; an analog-to-digital converter for digitizing the image signals to produce digital images; and a removable memory card for storing a plurality of digital image files corresponding to the digital images. The electronic still camera also includes an internal memory for storing at least one digital image to be displayed and a plurality of e-mail addresses; a processor for controlling the transfer of the digital images from the removable memory card to the internal memory and for producing a utilization file; and a display coupled to the internal memory for displaying at least one digital image. The electronic still camera further includes a user interface for selecting at least one e-mail address and for scrolling through the plurality of digital images stored on the removable memory card in order to display and select particular digital images to be transferred to the selected at least one e-mail address, wherein the utilization file includes the at least one selected e-mail address and the name of at least one digital image file to be transferred to the at least one selected e-mail address and the processor stores the utilization file on the removable memory card separate from the digital image files.

U.S. Patent Application No. 2002/0057449 filed by Edward N. Chapman et al. teaches a method and apparatus that automatically communicates status information relative to a document production job by a printer. An application file is provided that includes information to be reproduced as a document reproduction job. Preferably, the application file is encoded with a document description language. Email address information is embedded in the application file relating to the party or parties to receive the status information. The application file is sent to the printer. At the printer, the email address is detected. The application file is processed to produce a printed document and an email message is sent from the printer relative to the status of the document reproduction job.

U.S. Patent Application No. 2002/0062363 filed by Joe G. Naylor et al. discloses an invention that relates to a system which has a combined facsimile and electronic mail capability. The user stores fax telephone numbers and corresponding e-mail addresses into a fax machine. When the user activates the system, the fax machine sends both a fax and an e-mail to the intended recipient.

U.S. Patent Application No. 2002/0075506 filed by Duncan I. Stevenson et al. teaches a digital printer which resides on a network is, by itself, capable of accessing an electronic mail account which exists in an SMTP server on the same network. The user interface of the printer can be used to enter a network password and view headings of messages in the account associated with the network password. The user can then request the text or attachments of certain messages to be output at the printer. The system allows any user who has access to the network to retrieve electronic mail without a personal computer.

U.S. Patent Application No. 2002/0103697 filed by John Lockhart et al. discloses a method for generating and distributing mail items includes creating a first and a second mail file, wherein each of the first and second mail files includes recipient address information, and wherein the first mail file is generated by a first user, and the second mail file is generated by a second user.

The European standard setting body CEN has established a Hybrid Mail Language (HML) standard in January 2001. The standard, designated ENV 14014:2001 is a specification for “Postal Services—Hybrid mail—Document type definitions for customer to operator: a common set of default tags.” The CEN standards is based on a common set of printing architectures and resources and uses XML (Extensible Markup Language) and its DTD (Document type description) to describe the relevant elements. The concept includes description of an electronic mailbag, an electronic envelope, and an electronic page. The focus is made on the postal level and the possibility to process at each level independently of the others. The main information needed (i.e. postal and production) is separately and explicitly tagged. While the CEN hybrid standard addresses some of the issues of a bilateral hybrid package, the subject invention proposes a far simpler structure and user process for a multidirectional and message system neutral platform.

### SUMMARY OF THE INVENTION

Accordingly, the present invention transfers a message package from one communication system to another and re-directing it to an output site that shortens the time for ‘delivery’ of a message. The present invention utilizes the flexibility of, SGML, XML, HTML and similar codes combined with the simplicity of electronic financial management system for the large volume of micro-payments. The originating message can be an e-mail, a fax, a letter, a voice message, message created in a private message system (e.g. air line reservation system) or other message type. The subject invention shortens the time for delivery (and consequently the cost of the delivery) and manages the large volume of micro-payments in an efficient manner.

The Subject invention preferably includes:

The Message Preparation system

The Financial Management System

The Re-Direction Manager system, and

The Output system.

The Message Preparation system creates a standardized message package from any originating message system, permits the extensive use of sgml, html and xml formatting and messaging codes and standardizes the message to forward it to Payment Manager and the Re-Direction Manager. Routines A100 provides technical background and documentation on the use of the Message Preparation System. Routines A200 to A600 show the process of formatting non-uniform messages into the standardized message package. The Message Preparation System includes flexible structure and format of the standardized message package; the re-definition of the use of the ‘re-line’ in the email format; the dynamic use of xml code; the linkage to the Financial Management System; and the availability of an input wizard to ease the preparation of standardized message package and the generation of an estimated invoice from the Financial Management System.

The Financial Management System streamlines making multiple small payments, give the user multiple electronic payment choices, and handles the accounts electronically for all the individual users, input sub-operators, output sub-operators, and system operators. It also performs a number of financial administrative tasks. There are separate routines for user registration B100, costing the transformation of each message package B200, collecting payment from senders and input sub-operators B300, and settling accounts with the various input, output, and system operators B400. The Financial Management System includes the incorporation of the Ezpass-type payment system used on NY bridges and turnpikes as well as a link to an existing internal corporate financial management system as two of the payment options, the functioning of a pricing wizard that is adaptable to a range of individual payment components, and the dynamic generation of invoices and payment settlement arrangements between input sub-operators, output sub-operators, and the operator.

The Re-Direction Manager system ascertains the type of output communication system requested by the user and determines the best output device by matching the user's requests with the registered locations and daily capacities of the output devices staffed by output sub-operators. It also performs a number of administrative tasks. The administrative tasks handled by the re-direction manager include format checking C110, maintaining an inventory of output devices C120 and input devices C130, long term storage of the message and its delivery confirmation if requested by user C140, an internal generator of progress reports and error messages C150, a status of message and accounts reporting function C160, a source database supervisor C170 and an optional multiple output of a message to more than one communication system C180. In addition, there are separate routines C200 to C600 for each message communication system that selects the best output device in terms of speed of delivery and cost while being responsive to user requests and system capacities and handles the initial re-formatting of the output message. The Re-Direction Manager system includes a format checking routine, an internal system message generator to alert message senders of any difficulties in transmitting their message, and the ability to allow message senders and sub-operator to track the status of the delivery of a message.

The Output System reverses the creation of the standardized message package into the final output and maximizes the flexibility of the output using the sgml, html and xml codes. The administrative functions of the Output system include the dissemination of internally generated messages to senders D10 and a method of checking the financial account of the operators and sub-operators D120. In addition, there are five final output-processing stages (D200 to D600). The Output system includes the ability to take the standardized message package and re-format it for output in the new communication system in a manner that enhances the flexibility of the style of the final outcome message; and the availability of an output wizard that manages the email-output device linkage as well as the invoicing of the core operator.

The subject invention functions by combining all or part of each of these four systems, depending on specific configuration designed by the commercial operator.

It will be understood that the subject invention provides non-limiting advantages and uses that include faster delivery of domestic and international mail at a lower cost, (of interest to national, foreign and private postal systems, bulk mailers, print shops and fulfillment houses) delivery of letters behind a security (fire) wall (of interest to travel reservation systems and business entities with consumer loyalty programs, e.g., frequent flyer or hotel members) print shops used as postal centers (of interest to commercial printers and consumer photocopy centers), the e-mailing of messages to airline passengers and real time passenger arrival information from airlines (of interest to air travel reservation systems and businesses with consumer loyalty programs, e.g., frequent flyer or hotel members), and e-mail messages transmitted through the use of a telephone (of interest to local and regional telephone companies as well as support services for the visually impaired).

Thus, in one embodiment of the functioning of the present invention, a message sender sends an email to the central email server at an airline/airline club/hotel chain with the recipient's unique membership number in the “re-line” of the email message. The central email server would query the organizations' unique membership database for the next scheduled contact with the passenger/club member for a given number of days/hours, redirect the message via email or an internal corporate communication network to the appropriate local site, and set up a notification to the organizations “frontdesk” regarding the member's incoming message. Were the Central email server to discover that the passenger/club member was not scheduled to be in touch with the organization within the specific period, the central email server would generate an email message to the original sender stating such. Passenger/hotel guest could have the option to read the message on a monitor or have it printed.

### BRIEF DESCRIPTION OF THE DRAWINGS

The above and other objects and advantages of the present invention will become more readily apparent upon consideration of the following detailed description, taken in conjunction with the accompanying drawings, in which like reference characters refer to like parts throughout the drawings in which:

FIG. 1 Is a pictorial representation of a computer system which may be implemented with the present invention;

FIG. 2 Depicts a representative hardware environment of a computer system which may be implemented with the present invention;

FIG. 3 Flow Diagram of an overview of all of the systems of the invention;

FIG. 4 Flow Diagram of an overview of the Message Preparation System (A);

FIG. 5 Flow Diagram of an overview of the Financial Management System (B);

FIG. 6 Flow Diagram for Flow Diagram for the Financial Management System: User Registration Module: Individual User B1110 showing also B140 and B1350 support routines;

FIG. 7 Flow Diagram for the Financial Management System: User Registration Module: Input Sub-operator B1120 showing also B140 and B1150 support routines;

FIG. 8 Flow Diagram for the Financial Management System: User Registration Module: Output Sub-operator B130 showing also B140 and B150 support routines;

FIG. 9 Flow Diagram for Financial Management System: Pricing Module B200;

FIG. 10 Flow Diagram for Financial Management System: Payment Collection Module B300;

FIG. 11 Flow Diagram for Financial Management System: Settlement Module B400;

FIG. 12 Overview of the Re-Direction Management System (C);

FIG. 13 Flow Diagram for Re-Direction Manager System: Format checking module C110;

FIG. 14 Flow Diagram for Re-Direction Manager System: Inventory of Output Capacities C120;

FIG. 15 Flow Diagram for Re-Direction Manager System: Inventory of Input Capacities C130;

FIG. 16a Flow Diagram for Re-Direction Manager System: Inventory of Document Preservation and Security Options C140;

FIG. 16b Flow Diagram for Re-Direction Manager System: Internal Message Generator C150;

FIG. 17 Flow Diagram for Re-Direction Manager System: Email sub-manager C200;

FIG. 18 Flow Diagram for Re-Direction Manager System: Letter sub-manager C300;

FIG. 19 Flow Diagram for Re-Direction Manager System: Fax sub-manager C400;

FIG. 20 Flow Diagram for Re-Direction Manager System: Restricted access internal communication message sub-manager C500;

FIG. 21 Flow Diagram for Re-Direction Manager System: Telephone/Audio system sub-manager C600;

FIG. 22 Overview of the Output System (D);

FIG. 23a Flow Diagram for Message Output System: “mail merge” preparatory module D120;

FIG. 23b Flow Diagram for Message Output System: output software module D130;

FIG. 24 Flow Diagram for Message Output System: Email Message Delivery Format D200;

FIG. 25 Flow Diagram for Message Output System: Letter Message Delivery Format D300;

FIG. 26 Flow Diagram for Message Output System: Fax Message Delivery Format D400;

FIG. 27 Flow Diagram for Message Output System: Letter Message Delivery Format D500; and

FIG. 28 Flow Diagram for Message Output System: Letter Message Delivery Format D600.

### DETAILED DESCRIPTION OF THE PREFERRED EMBODIMENTS DEFINITIONS

The following definitions are to be considered illustrative and exemplary as opposed to limiting, with respect to the subject invention.

“non-postal code system” is any institutional-client system whose primary purpose is not the delivery of individual messages but which maintains sufficient unique client identifiers for it to supplement or enhance their activities with a system of the present invention (e.g. an airline and its frequent flyer account numbers; an employer and personnel id numbers or telephone extensions; or a university system and its student id numbers).

“sub-operator” is a commercial or institutional enterprise (e.g. a cyber cafe or a “Kinko” print store) or government office or institution capable of operating a non-postal code system which serves as a ‘postal’ site for the purpose of transmitting a message to, or outputting a message from, the system of the present invention. A sub-operator can be an input sub-operator, an output sub-operator, or both, and it can be the initiator or recipient of messages on its own, or on a related firm's behalf.

“operator” is an institutional enterprise or a government office (e.g. a post office) that supplements its existing functions with the management of the system of the present invention. An operator may also perform some of the functions of a sub-operator.

“standardized message package” (SMP) is a user message accompanied by sufficient sender and recipient information to permit the transformation, re-direction and delivery of the original message, such package having a “cover note section” (CNS) with the functional instructions and a “message body section” (MBS) with the core message from the sender.

“EZ pass” type payments are a pre-authorization system where the user allocates to the system operator a fixed amount of money, and grants that operator the right to charge a credit card or other electronic payment system whenever the minimum balance is below the agreed amount, and the system operator manages the account to permit the user to draw down the balance at the user's convenience as done by, for example, the “EZPass” turnpike payment system.

“trust accounts” are accounts maintained by operators on behalf of individual users or sub-operators including the operation of accounts in trust for receivables and payables.

“SGML-defined tags” are double sided tags following the basic format convention for the family of SGML (ISO standard), XML (a superset of SGML), HTML (a subset of SGML) standards and related audio markup languages and that use their normal or assigned meanings and, when used herein, are intended as only non-limiting examples of “computer mark-up languages” in general, any of which can be employed with the subject invention.

“station” is a vending type machine, generally under the control of a sub-operator, which permits the creation of a message package from a letter, other printed matter, or from user-supplied input to the station, or is a self-standing machine under the control of a sub-operator that permits the receipt of a standardized message package.

“contact address” is a complete address as recognized by any specified message system (e.g. a postal address, telephone number, email address) inclusive of any recognized codes required for globally unique identification.

“country designation” can be a country name or one of its recognized country codes.

The implementation of this patent is based on existing hardware that is or functions similarly to a fax machine, a personal computer with internet and/or intranet connections, scanners, the hardware behind the internet itself, printers (mostly high speed) linked to a computer or an supported by a computer net, voice and audio transmission systems, a combination of the above input devices into vending machine arrangement, a postal franking machines, folding and stuffing equipment, computer storage disks or related storage technologies and vending or other self-service hardware that incorporates the hardware listed above. The implementation of this patent is based on existing software that is or functions similarly to existing computer operating systems, word processing software, email software, voice and audio software, generalized accounting and billing software, software that interfaces with credit card and banking systems, graphic software, software to manager internet and intranet access, software similar with or identical to the C++ family and Visual Basic family of higher order languages, file le and file security software, as well as various hardware device drivers.

### DETAILED DESCRIPTION

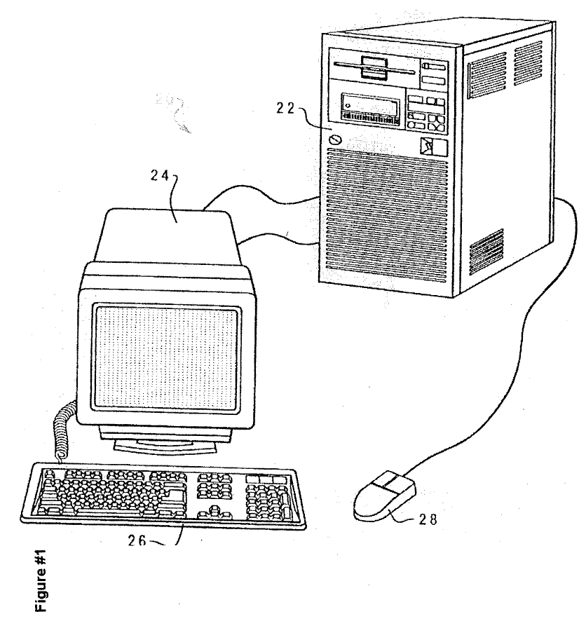

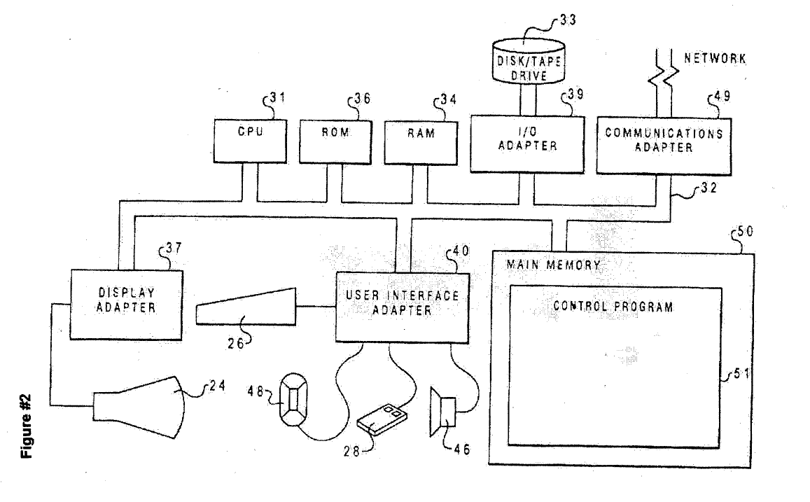

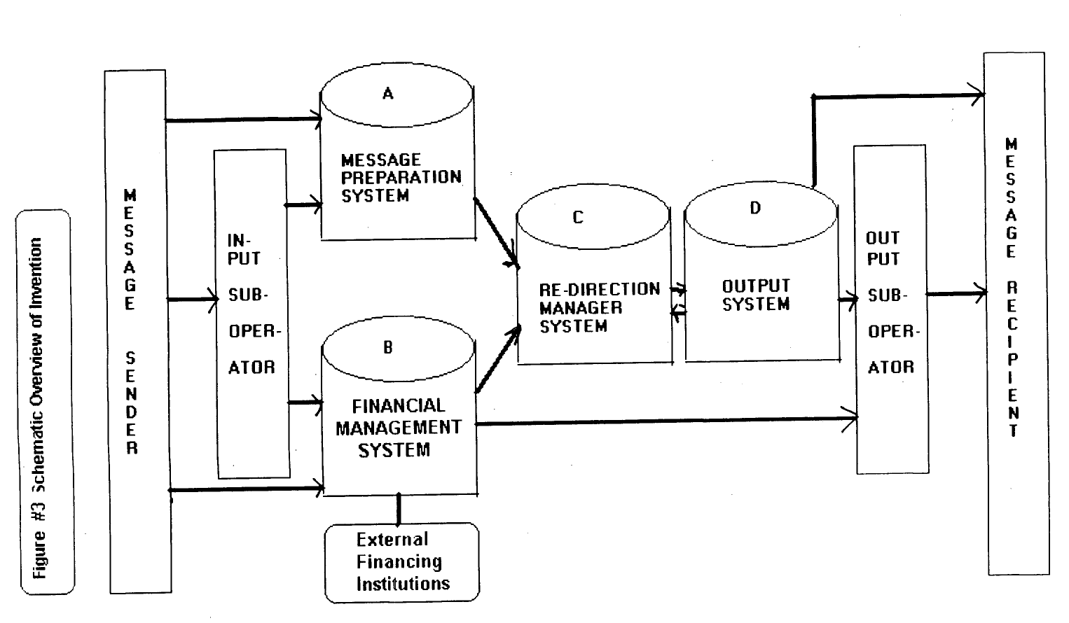

With reference now to the figures and in particular with reference to FIG. 1, there is depicted a pictorial representation of a computer system in accordance with a preferred embodiment of the present invention. A computer system 20 is depicted that includes a system unit 22, a video display terminal 24, a keyboard 26, and a mouse 28. Computer system 20 can be implemented utilizing any suitable computer such as an IBM personal computer of International Business Machines Corporation, located in Armonk, N.Y. However, those skilled in the art will appreciate that the mechanisms and apparatus of the present invention apply equally to any computer system, regardless of whether the computer system is a complicated multi-user computing apparatus or a single-user workstation. In FIG. 1 and FIG. 2, like parts are identified by like numbers.

FIG. 2 depicts a representative hardware environment of the computer system of a preferred embodiment of the present invention. Computer system 20 includes a Central Processing Unit (“CPU”) 31, such as a conventional microprocessor, and a number of other units interconnected via system bus 32. Such components and units of computer system 20 can be implemented in a system unit such as system unit 22 of FIG. 1. Computer system 20 further includes random-access memory (“RAM”) 34, read-only memory (“ROM”) 36, display adapter 37 for connecting system bus 32 to video display terminal 24, and I/O adapter 39 for connecting peripheral devices (e.g., disk and tape drives 33) to system bus 32.

Video display terminal 24 displays the visual output of computer system 20. Video display terminal 24 can be CRT-based video display well-known in the art of computer hardware. However, with a portable or notebook-based computer, video display terminal 24 can be replaced with an LCD-based or a gas plasma-based flat-panel display. Computer system 20 further includes user interface adapter 40 for connecting keyboard 26, mouse 28, speaker 46, microphone 48, and/or other user interface devices, such as touch-screen device (not shown), to system bus 32. Communications adapter 49 connects computer system 20 to a computer network. Although computer system 20 is shown to contain only a single CPU and a single system bus, it should be understood that the present invention applies equally to computer systems that have multiple CPUs and to computer systems that have multiple buses that each perform different functions in different ways.

Computer system 20 also includes an interface that resides within a machine-readable media to direct the operation of computer system 20. Any suitable machine-readable media may retain the interface, such as RAM 34, ROM 36, a magnetic diskette, magnetic tape, or optical disk (the last three being located in disk and tape drives 33). Any suitable operating system and associated interface (e.g., Microsoft Windows) may direct CPU 31. For example, the AIX operating system and AIX windows windowing system can direct CPU 31. The AIX operating system is IBM's implementation of the UNIX operating system. UNIX is a trademark of UNIX Systems Laboratories, Inc. Other technologies also can be utilized in conjunction with CPU 31, such as touch-screen technology or human voice control. Those skilled in the art will appreciate that the hardware depicted in FIG. 2 may vary for specific applications. For example, other peripheral devices such as optical disk media, audio adapters, or chip programming devices, such as PAL or EPROM programming devices well-known in the art of computer hardware and the like, may be utilized in addition to or in place of the hardware already depicted.

Main memory 50 is connected to system bus 32, and includes a control program 51. Control program 51 resides within main memory 50, and contains instructions that, when executed on CPU 31, carries out the operations depicted in some of the logic flowcharts.

It is important to note that, while the present invention has been (and will continue to be) described in the context of a fully functional computer system, those skilled in the art will appreciate that the present invention is capable of being distributed in a variety of forms.

The subject invention preferably consists of one or more of four components: a document preparation system, a micro-payment collection and accounting system, a re-direction manager and a flexible formatted output generator. The message system of the present invention integrates these separate systems into a common system for message transformation and re-transmission. For certain specific cases, where one firm undertakes multiple tasks, it is possible to create an effective message system working with less than all the sub-systems.

A—Message Preparation System

In the Message Preparation System shown in FIG. 1, a message sender can use a variety of communication systems to prepare a message or a message package such as email A200, letter A300, fax A400, audio message system A500 (e.g. telephone), private internal communication system A600 or similar communication systems, each of which is described separately below. Incoming messages from other electronic message communication system formats, such as the CEN hybrid mail language standard ENV 14014:2001, may be converted by a software fix into one of the above systems. A110 would provide downloadable instructions and manuals as well as on-line help support for each of the separate communication systems.

The implementation of the Message Preparation System is based on existing hardware that is or functions similarly to a fax machine, a personal computer with internet and/or intranet connections, a scanner, the hardware behind the internet itself, printers (mostly high speed) linked to a computer or an supported by a computer net, voice and audio transmission systems, and combination of the above in a vending machine arrangement. Users can also utilize compression/decompression software and encryption software. The implementation of this patent is based on existing software that is or functions similarly to existing computer operating systems, word processing software, email software, voice and audio software, graphic software, Internet and intranet software, file and file security software, as well as various hardware device drivers.

In each communication system, a standardized message package (SMP) would consist of a cover note section (CNS) and a message body section (MBS). (See Table 1).

TABLE 1
Technical Structure of the Standardized Message Package
Cover Note Portion

| | |
|---|---|
| | REQUIRED USER-SUPPLIED COMPONENTS |
| <reline> [1] | must contain either |
| | (a) country designation and postal code, |
| | (b) non-postal system code and non-postal system recipient's |
| | unique id, |
| | (c) country designation and a fax number or |
| | (d) country designation and a telephone number |
| | and optionally can contain |
| | a backup fax number; a backup telephone number; a request for a |
| | costing estimate; and an output priority code |
| <sname> [1] | Sender's full name |
| <scontactid> [1] | must contain either the sender's |
| | (a) full postal address; |
| | (b) email address; |
| | (c) non-postal system code and non-postal system recipient's |
| | unique id; |
| | (d) country designation and a fax number or |
| | (e) country designation and a telephone number |
| | and optionally can contain an alternate contact id |
| <rname> [1, 2] | Recipient's full name |
| <rcontactid> [1, 2] | must contain either the recipient's |
| | (a) full postal address; |
| | (b) email address; |
| | (c) non-postal system code and non-postal system |
| | recipient's unique id; |
| | (d) country designation and a fax number or |
| | (e) country designation and a telephone number |
| | and optionally can contain an alternate contact id |
| <outputformat> | Indicator of the output communication system (e.g. |
| | email/letter/fax/internal message/audio) |
| <outputstyle> | Indicator of the designated output style (e.g. for a letter/fax formats: |
| | business or personal letter styles) |
| <msglocation> | Indicator if the content of the message is attached or included in the |
| | body of the email |
| <payform> | Indicator if the payment form is the default or one of a series of |
| | alternative payment systems |
| <paypersonalcd> | Secure personal payment code recognized by <payform>; a null |
| | entry indicates that the recipient will be meeting the incoming costs |
| | of the message |
| <paymentcd> | Indicator of payment confirmation generated by Financial |
| | Management System (encoded) |
| | REQUIRED COMPONENTS: SYSTEM GENERATED |
| <msgid> | Unique identification for each SMP, generated by format checker |
| <inputformat> | Indicator of input communication system (e.g. for a email/letter/ |
| | fax/internal message/audio), generated by format checker |
| <outputlen> | Indicator of number of output “pages” per unique message package, |
| | generated by format checker |
| | OPTIONAL USER SUPPLIED COMPONENTS |
| <rlistname> [2] | The name of the attached mail merge document containing pairs of |
| | <rname> and <rcontactid> sgml codes |
| <rnamecount> [2] | The count of the number of names in the mail merge document |
| <subopid> | Unique identification for an input sub-operator. Value provided |
| | input sub-operator at conclusion of registration B120 |
| <msgsecurity> | Indicator if system is to preserve document and/or a confirmation |
| | of delivery with a date and time stamp |
| <msgconfirm> | Indicator if message sender requires confirmation of delivery sent |
| | to originating site |
| <headertxt> | Text to appear at top of each page or message |
| <footertxt> | Text to appear at bottom of each page or message |
| <logo> [3] | Name of attached file containing a logo or similar graphic |
| <addmsgunits> | Name(s) of attached files in sequence for delivery by second |
| | communication system |
| <placementopts> | Indicators for the placement of <headertxt>, <footertxt>, and |
| | <logo> |
| <prenmtitle> | Special text that should precede <rname> |
| <postnametitle> | Special text that should follow <rname> |
| <orgname> [3] | Organization name of <rname> |
| <sreturnaddress2> | Preferred return address for use in generating final message in |
| | second output system |
| <optsquality> | Indicator if quality options for designated output communication |
| | system <outputformat> if not default value |
| <optspriority> | Indicator of delivery system priorities if not default value |
| <optswithinsys> | Indicators for features within delivery systems (e.g. language codes |
| | for use of voice synthesizers) |
| <optsgml> | Other sgml designated output related options |

Message Body Portion

OPTIONAL COMPONENTS
Html format related codes
Xml defined format codes
Other Standardized Generalized Markup format codes
Sound based format codes
Video based format codes
Other media defined format codes

[1] would have sub elements containing components of main sgml type code; For email inputs these required elements can be located in email “to”, “from” and “re” lines
[2] if there is a single recipient, <rname> and <rcontactid> is used; otherwise <rlistname> and <rnamecount> are used.
[3] multiple values are possible

1. A110—Message Preparation System: Documentation and User Support for the Message Preparation Process

Using input from the registration software modules B110, B120, and B130 (below, the Documentation and User Support module A110 of the message preparation system would provide users downloadable instruction guides as well as on-line help services. A100 would permit a message sender to query the input sub-operators capacity database C134 to locate appropriate sites for submission of an SMP.

2. A200—Message Preparation System: Email Originating Message

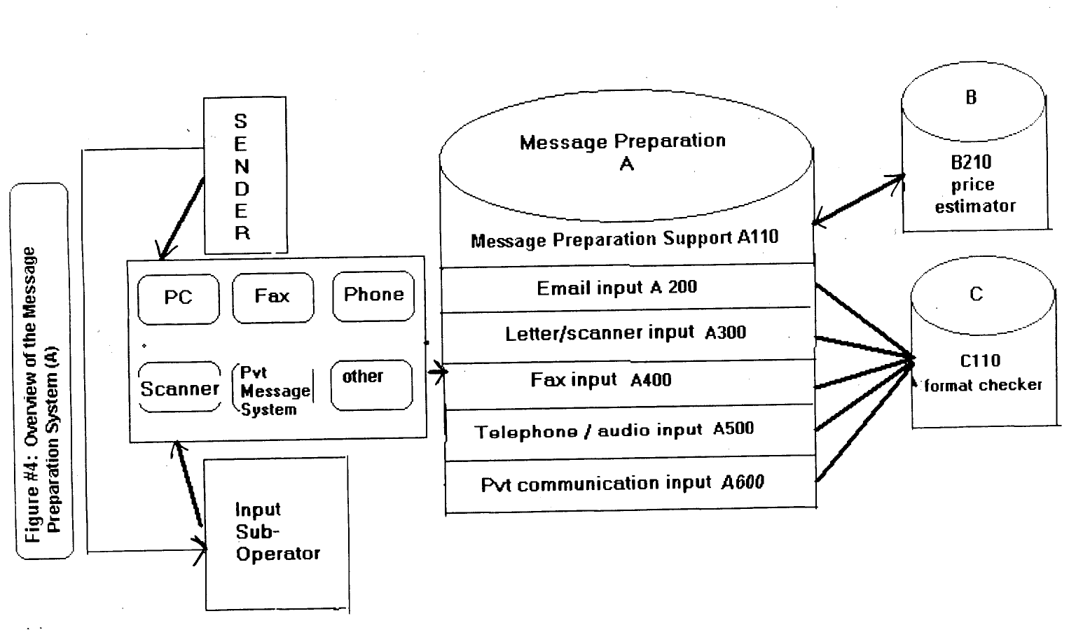

Referring to FIG. 4, for an email-originating message A200, the message sender can generate a SMP using any terminal with an input device (such as a key pad, touch pad, mouse or similar input device) and any email software (such as, for example, Microsoft Outlook or Lotus Notes) with the appropriate connections to the Internet such as dial up access, DSL, cable, satellite, wireless, LAN, WAN or similar communication channel). An email originating message A200 would have the following header format (a) “To line” contains the email address of a operator or sub-operator and (b) the “re-line” must contain either (i) country designation and postal code; restricted access internal communication system code and that system's unique id for the recipient; country designation and a fax number; or country designation and a telephone number. The “re-line” can optionally contain a backup recipient contact address, a request for a costing estimate and/or an output priority code.

In email-originating message A200 the CNS, demarked by html, xml or other sgml codes in the message section of an email, contains at least XML or other SGML defined and required codes for (i) sender's full name <sname>, and contact address<scontacid>; (ii) either recipient's full name <rname>, and contact address <rcontacid> and their components or a count of the number of “mail merge” addressees <rnamecount> and the name of an attached file containing a list of recipients' full names and contact addresses in “mail merge” format <rlistname>; (iii) indicator of the output message system (letter/fax/private internal/audio/etc) <outputformat>; (iv) indicator of the designated output format style (e.g. for a letter business/personal)<outputstyle>; (v) indicator if the content of the message is attached or included in the body of the email <msglocation> and (vi) a financial source code <payform> and financial sender id<paypersonalcd>. The financial source code and the financial sender id can be null if the recipient has pre-arranged to meet the costs for all incoming messages or classes of messages (as in 800/888 telephone numbers).

The CNS can contain supplemental HTML, XML, or SGML-defined tags indicating (i) document preservation and security codes <msgsecurity>; (ii) confirmation of delivery choice options <msgconfirm>; (iii) header or footer text, <headertxt>; (iv) a logo <logo>; (v) options for the placement of a logo, header, or footer <placementopts>; (vi) title of recipient <postnametitle>; (vii) organization and section of organization of recipient <orgname>; (viii) special quality output instructions <optsquality>; (ix) output priority codes <optspriority>, (x) instructions for managing multiple attachments <addmsgunits> (xi) for a message to be output via a voice synthesizer, a language code <optswithinsys> (xii) other return address to use on final message <sreturnaddrss2> and (xiii) others such features <optssgml>.

The MBS can use a range of existing HTML (e.g. font names, font size, bold/italics, background, foreground, and text colors) XML, or SGML-defined instructions. The attachment section can include (a) the MBS (if the MBS itself is not already in the body of the email) using agreed sgml type or similar format-defining tags in any agreed file formats including, but not limited to, .doc, .pdf, .wav. and .mp3; (b) supplemental message attachments; and (c) a list of multiple names and contact addresses, formatted to the appropriate standard. When the designated output communication system is a postal, telephone, or fax system, the mail merge list should contain contact addresses directed to a single postal or telephone code or a group of related such codes. An email wizard software program may be used to assist in the preparation of appropriately formatted email messages.

The message sender transmits SMP to a designated email address maintained by the system operator or sub-operator. The SMP is received by the operator's email system and forwarded to the format checking module C110 of the re-direct manager system unless the “re-line” contains a request for a costing estimate, in which case the SMP is forwarded to pricing module B200.

3. A300—Message Preparation System: Letter Originating Message

Referring to FIG. 4, for a letter originating message A300, the message sender can generate a SMP by providing the requisite CNS information and letter message either (a) directly to a sub-operator (e.g. at a local postal office) or to an non-postal system operator (e.g. at a store counter) who utilizes personal computer or other input device and an on-line wizard software program to create the formatted CNS and a scanner (or other relevant device) connected to the sub-operator's computer system to transfer the originating letter to a e MBS file which merged together form a SMP; (b) indirectly to a sub-operator via on an EZ station/terminal connected to a sub-operator computer system and a scanner (or other relevant device) connected to the sub-operator's computer system to transfer the originating letter into a MBS file which merged together form a SMP; (c) directly to an operator or sub-operator via a vending machine based station containing a personal computer or a terminal linked to a mainframe, a scanner and/or keyboard; or (d) a combination of the above. The operator or sub-operator using any terminal with an input device (such as a key pad, touch pad, mouse or similar input device) and any email software (such as, for example, Microsoft Outlook or Lotus Notes) with the appropriate connections to the Internet such as dial up access, DSL, cable, satellite, wireless, LAN, WAN or similar communication channels) transmits the SMP as an email to a designated operator.

The format of the SMP is the same as the email format above except that (a) the CNS is on a separate page; (b) “re line” information <reline> moves to the first line of the CNS with SGML-type code markers; (c) the indicator if the content of the message is attached or included in the body of the email is null <msglocation>; (d) an indicator of the number of pages is provided <outputlen>; and (e) an indicator if the message contains SGML, HTML, XML or other agreed output codes or if the message format is in its final format <outputformat>.

The MBS, itself, starts on a separate page and initially is a separate file. With the assistance of the sub-operator, supplemental graphics or audio attachments can be added to the MBS. Any list of multiple names and contact addresses of recipients start on a separate page with appropriate sgml-type or similar formatting code markers, initially as a separate file, and finally as a separate attachments to a SMP email. A wizard software program may be used to assist in the preparation of appropriately formatted letter messages.

The sub-operator or the vending machine software undertakes the following steps (a) transforms the CNS page into the body of an email and the MBS page and any mail merge pages into attachments to the email; (b) inserts the appropriate system email address into the “To-Line”<reline>; (c) emails the SMP to financial pricing module B200 for pricing information OR uses the client-side pricing wizard; (d) collects financial information from letter sender; (e) adds sub-operator's financial authorization code to the CNS <paymentcd>; and (f) forwards via email the sub-operator revised SMP to the appropriate operator system site.

The sub-operator revised SMP is received by the operator's email system and forwarded to the format-checking module C110.

4. A400—Message Preparation System: Fax Originating Message

Referring to FIG. 4, for a fax originating message A400, the message sender can generate a SMP by providing CNS and the MBS separately to (a) a sub-operator (e.g. at a store counter) who scans the two components of the originating message into their fax machine which is connected directly or indirectly with their personal computer or other computer system; (b) directly from the sender's fax machine via telephone lines to the designated fax number of an operator or sub-operator's personal computer or other computer system; or (c) a combination of the above. A wizard software program could be used by a sub-operator at a storefront to assist in the preparation of appropriately formatted fax message. A wizard software program could be used to assist in the preparation of appropriately formatted fax message under option (a) above.

The format of the SMP for a message originating as a fax is the same as letter format in A300 above except (a) an indicator of the number of fax pages is provided and the number of discrete fax attachments is provided <outputlen> and (b) an indicator if the message contains SGML/HTML/XML or other agreed output codes or if the message format is in its final format <outputformat>.

On receipt of a fax input message, the sub-operator undertakes the following steps (a) transforms the CNS fax page into the body of an email and the MBS page and any mail merge pages into attachments to the email; (b) inserts the appropriate system email address into the “To-Line”<reline>; (c) emails the SMP to the financial pricing module B200 or uses a client-side pricing wizard; (d) collects financial information from fax sender; (e) adds sub-operator's financial authorization code to the SMP; and (f) forwards via email the sub-operator revised SMP to the appropriate operator re-direction system site.

The SMP is received by the operator's email system and forward to the format-checking module of the re-direct manager system C110.

5. A500—Message Preparation System: Telephone/Audio Originating Message

Referring to FIG. 4, for a telephone/audio originating message A500, the message sender can generate a SMP by providing the requisite information (a) directly to an operator or sub-operator, (e.g. telephone service company), who utilizes an on-line wizard software program to query the sender for the necessary information; for the CNS and provides a tape recording device or a similar digital recording device for the sender to provide the MBS; (b) indirectly to an operator or sub-operator (e.g. a telephone company) via on voice-activated query system over a telephone line to obtain the relevant information for the CNS and the MBS which would be stored on a tape recording device or similar digital recording device; (c) directly to an operator or sub-operator via a special telephone equipped booth, with a keyboard or similar input device; or (d) a combination of the above.

This SMP format is the same as the email format, above, except that (a) the CNS starts with a distinctive audio sound/message; (b) contains a series of distinctive audio messages prompting audio and/or telephone key pad replies for the relevant information for each required or optional variable in the CNS; (c) an indicator if the content of the message is attached or included in the body of the email is null <msglocation>; and (d) special audio output SGML-type indicators can be utilized <outputformat, outputstyle>. The MBS, itself, starts with a distinctive audio sound/message and concludes with a fixed key input code. A wizard software program may be used to assist in the preparation of appropriately formatted telephone-based messages.

The operator or sub-operator and the associated audio input wizard software program undertakes the following steps (a) converts the CNS audio information into the body of an email message and transfers the audio substantive message into an audio-file format suitable as an attachment for email transmission (currently .wav and .mp3); (b) calculates the length of the audio message is terms of its designated output communication system; (c) emails the assembled SMP to pricing module B200 or uses a client-side pricing wizard software program; (d) collects financial information from audio message sender; (e) adds sub-operator's financial authorization code to the CNS of SMP; and (f) forwards via email the current SMP to the appropriate re-direction system site. If the designated user financial system is the user's telephone service account, then sub-steps (d) and (e) are omitted.

The SMP is received by the operator's email system and forward to the format-checking module of the re-direct manager system C110.

6. A600—Message Preparation System: Message Originating from a Restricted Access Internal Communication System

Referring to FIG. 4, for a message originating from a restricted access internal communication system A500, the message sender can generate a SMP by providing the requisite information either (a) directly to a sub-operator (e.g. a particular internal communications office) who utilizes an on-line wizard software program to create the CNS, and a personal computer to combine a message from a restricted access internal communication system message body, together as an SMP (b) indirectly to a sub-operator via a modification of the output from a restricted access internal communication system connected to a sub-operator site; (c) directly to an operator or sub-operator via a an email link from a restricted access internal communication system; or (d) a combination of the above. The particular configuration of the existing restricted access internal communication system will determine for the most part the nature of the hardware connection to the Internet and/or the software bridge used to the Internet.

The format of the SMP for a message originating from a restricted access internal communication system is the same as the email format, above, except that on the CNS (a) the “to line”<re-line> could also be an address of the operator of a restricted access internal communication system (e.g. an airline) serving as a sub-operator or an email link to an outside sub-operator or operator; and (b) the “subject line” could be another restricted access internal communication code and unique recipient id.

The message sender transmits the SMP to a designated internal sub-operator (or link to external communication systems) maintained by the system operator or sub-operator. The operator or sub-operator software undertakes the following steps (a) transforms the CNS information into the body of an email, and the MBS page and any mail merge pages into attachments to the email; (b) inserts the appropriate system email address into the “To-Line”<re-line>; (c) emails the SMP to the financial pricing module B200, or uses the client-side pricing wizard; (d) collects financial information from the internal message sender; (e) adds sub-operator's financial authorization code to the SMP; and (f) forwards via email the SMP including the financial authorization code to the appropriate re-direction system site.

The SMP is received by the operator's email system and forward to the format-checking module of the re-direct manager system C110.

B—Financial Management System

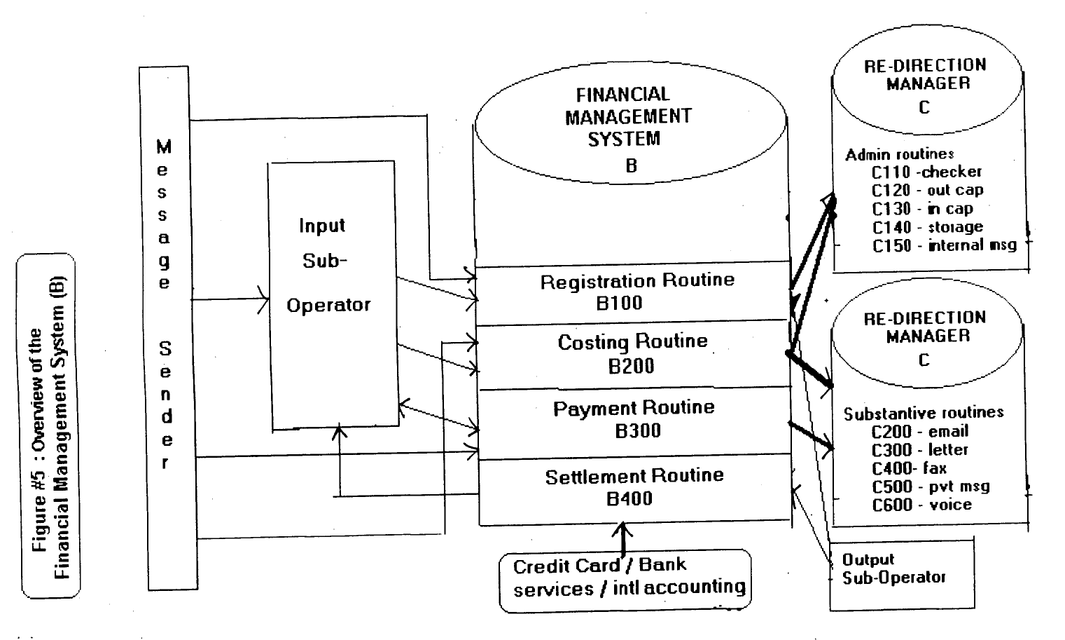

The Financial Management System of the present invention, as shown in FIG. 5, has a user registration component B100, a pricing routine B200, a payment collection module B300, and a settlement module B400, each of which is described below.

The implementation of the Financial Management System of this patent is based on existing hardware that is or functions similarly to a personal or a main frame computer with internet and/or intranet connections, the hardware behind the internet itself, printers (mostly high speed) linked to a computer or an supported by a computer net, and computer storage disks or related storage technologies. The implementation of this patent is based on existing software that is or functions similarly to existing computer operating systems, email software, generalized accounting and billing software, software that interfaces with credit card and banking systems, graphic software, internet and intranet software, file and file security software, as well as various hardware device drivers.

1. B100—Financial System: User Registration Module

The User Registration Module B100 has an individual user registration routine B110, an input sub-operator registration routine B120, an output sub-operator routine B130, registration supervisory and audit routine B140, and a series of registration support routines B150.

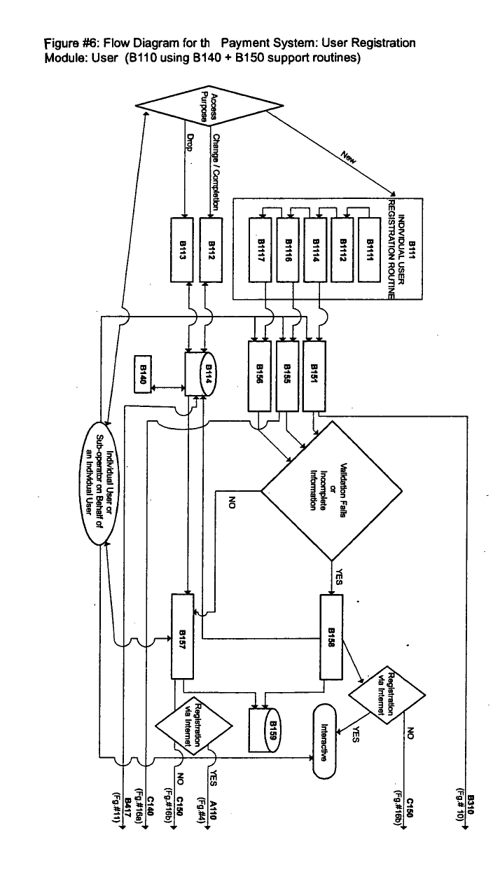

Referring to FIG. 6 individual user registration routine B110 can function in one of at least four possible methods (a) via the Internet and an interactive interface with the operator's or sub-operator's system, (b) via an interview with staff at an operator and sub-operator site who, with a PC interface, take registration information via email or phone (c) via a written (email, fax, or letter) registration, (d) via restricted access internal communication system, or (e) a combination of the above.

Individual user registration routine B110 first determines if access is for a (a) new registration, (b) a change in an existing registration/completing of the registration process, or (c) a request to drop registration. If it is a new registration, the individual user registration routine B111 requests a user (a) to provide a name, address, and relevant contact information at B1111, (b) to change default values for a number of input and output options at B1112; (c) to specify financial preferences through a call to payment selection operations routine B151 at B1114; (d) to select various document preservation and security preferences through a call to document preservation and security preferences B155 at B1216 and (e) to request categories of sender or recipient client discounts through a call to client or recipient discount routine B156 at B1117. The information is used to create a record in a user database B114. If there is incomplete information or error messages from B151, B155 or B156, control shifts to registration incomplete B158; otherwise control shifts to registration confirmation B157.

If the access to the user registration routine B100 is to change in an existing registration or complete a prior effort at registration, B112 queries the user for his/her unique id and password and, if valid, shows the current record to the user and requests the selection of elements to add or change. If additions or changes are made at B112, the changes are recorded in user database B114, and control is then transferred back to user or sub-operator.

If the access is a request to drop registration, at B113, the user is asked for his/her unique id and password and, if valid, is shown the current record and asked to confirm the request to withdraw. If the user has pending cash reserves in the direct client trust account B310, arrangements are made for a refund at B417 and control returns to the user or sub-operator. If confirmation is made and any account settlement is completed, the record in user database B114 is marked for deletion.

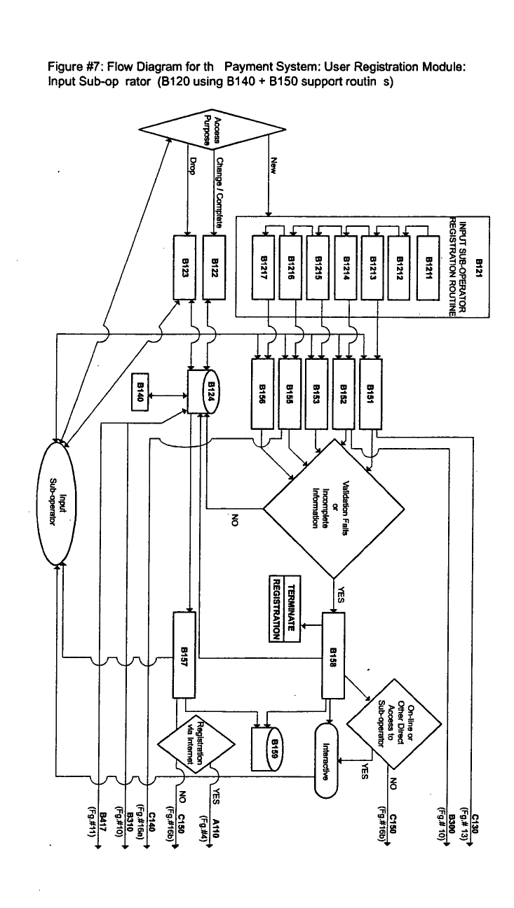

Input sub-operator registration routine B120 (see FIG. 7) can use one of at least three possible interfaces (a) interactive interface via the Internet to an operator's website; (b) staff interviews taking the registration information via phone, fax, or letter; (c) registration via restricted access internal communication system; and (d) a combination of the above.

The input sub-operator registration routine B120 first determines if access is for (a) a new registration at B121; (b) a change in an existing registration/completion of an ongoing registration at B122; or (c) a request to drop registration at B123. If it is a new registration, at B121 a potential sub-operator is requested (a) to provide their business name, address, financial references, staff to be granted access permissions and relevant contact information at B1211; (b) to verify default values for a number of input and output options at B1212; (c) to document input capacity offered by the potential sub-operator using B153 at B1213; (d) to select financial preferences using payment selection options routine B151 at B1214; (e) to select settlement preferences using settlement preferences routine B152 at B1215; (f) to set various default document preservation and security preferences using document preservation and security preferences B155 at B1216 and (g) to request or offer categories of sub-operator discounts using client or recipient discount routine B156 at B1217. Information is used to create a record in the sub-operator database B124. If there is incomplete information or error messages from B151, B152, B153, B155 or B156, control shifts to registration incomplete B158; otherwise control shifts to registration confirmation routine B157.

If the action is a change in an existing registration or the completion of a prior registration effort at B122, a sub-operator is requested to provide their unique sub-operator id, sub-operator password, staff id and password and, if valid, shows the staff at the sub-operator the current record of the sub-operator, and requests information to change elements. If additions or changes are made at B122, the additions or changes are recorded in sub-operator database B124 and control is then returned to the sub-operator.

The action is a request to drop registration, at B123 a sub-operator is requested to provide their unique sub-operator id, sub-operator password, staff id and staff password and, if valid, shown the current record and is asked to confirm withdrawal. If the user has pending cash reserves in the direct client trust account B310 or settlements pending B400, arrangements are made for refund(s) at B417 and control is then returned to the sub-operator. If confirmation is made at B123 and all accounts are settled, the record in the sub-operator database B124 is marked for deletion.

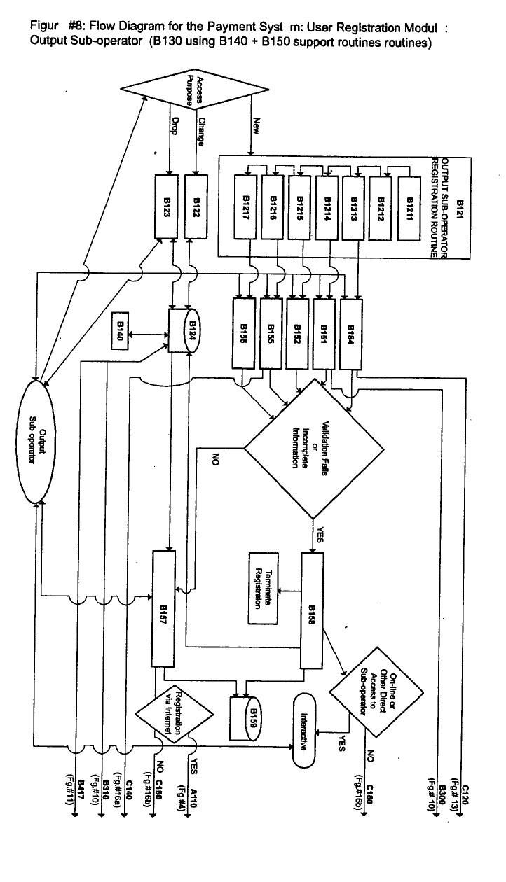

Referring to FIG. 8, the basic access options for the output sub-operator registration routines B130 are identical those as in input sub-operator registration routine B120 above, except as noted below. If it is a new registration of an output sub-operator, the routine at B131 is identical to at B121 except that the output sub-operator is requested in step (c) to document output capacities output capacities inventory routine B154.

The registration supervisory and audit routines B140 permits an operator to undertake a number of managerial tasks such as (a) maintaining the database B114 and the sub-operator database B124; (b) over-riding and correcting entries in these databases; (c) authorizing client and recipient discounts; and (d) reviewing the status of the registered output and input capacities currently available. Registration supervisory and audit routine B140 also permits the cross-registration with multiple capacities at a given site for the functions of input sub-operators, output sub-operators, and system operator(s).

Registration support routine B150 consist of the payment selection options routine B151; the settlement preferences routine B152; input capacities inventory routines B153; output capacities inventory routines B154; document preservation and security preferences B155; client or recipient discount routine B156;—the registration confirmation routine B157; and the registration incomplete routine B158.

Payment selection options routine B151 provides range of payment options to the user, including an option, which permits payments for incoming messages. If a user selects a “credit card/direct debt card” option, payment selection options routine B151 validation with external credit card, debt card agency or banking system is requested. If a user selects “a “restricted access internal communication system” or an “internal charge line”, the payment selection options validates request ion with the appropriate internal accounting system. If the validation fails, payment selection options routine B151 an appropriate section of the error message at B158 is conveyed to the internal message generator of the re-direct manager system C150 or a follow-up dialogue to the individual user or sub-operator (depending on the registration route chosen) is generated.

If a user or sub-operator selects a “pre-payment/reserve account” (an EZ pass type payment system), payment selection options routine B151 (a) credit card/debt card information, is requested (b) a range of minimum balance payments are offered, and (c) requests to establishes initial payment from the appropriate institution calling direct client trust account system B310. If the establishment of a new trust account fails, payment selection options routine B151 generates an appropriate section at B158 of the error message to internal message generator C150 or a follow-up dialogue to the individual user or sub-operator, depending on the registration route chosen.

Settlement preferences routine B152 provides the sub-operator with information on licensee terms, commissions and volume discounts, and confirms that arrangements are acceptable. If not, at B158 an exit is provided; alternatively, settlement preferences routine B152 continues providing (a) an acceptable range of choices for settlement of accounts (e.g. electronic funds transfer, periodic checks); (b) records selection options and payment details in the accounting section of the user (B114) or sub-operator (B124) database and (c) confirms financial arrangements. If the validation fails settlement preferences routine, B152 generates an appropriate section of the error message to internal message generator C150, or a follow-up dialogue to the sub-operator, depending on the registration route chosen.

Input capacities inventory routines B153 provides the sub-operator with a list of available input devices. After selecting available input devices, input capacities inventory routine B153 (a) queries the sub-operator for ISP address and other relevant information for the device; (b) loops until all devices are inventoried; and (c) confirms input capacities statement. If confirmation is positive, input capacities inventory routine B153 prepares to record input capacities in sub-operator database B124 and in the inventory of input capacities C130. If the information is incomplete or inaccurate, payment selection options routine B151 provisionally records the information provided and generates an appropriate section of the error message to internal message generator C150 or a follow-up dialogue to the sub-operator, depending on the registration route chosen.

Output capacities inventory routines B154 provides the sub-operator with a list of available output devices. After selecting from the available output devices, output capacities inventory routine B154 (a) queries sub-operator for ISP address and other relevant information of the device; (b) loops until all devices are inventoried; and (c) confirms output capacities statement. If confirmation is positive, output capacities inventory routine B154 records output capacities in sub-operator database B124 and in the inventory of output capacities C125. If the information is incomplete or inaccurate, output capacities inventory routine B151 provisionally records the information provided and generates an appropriate section of the error message to internal message generator C150 or a follow-up dialogue to the sub-operator, depending on the registration route chosen.

Document preservation and security preferences B155 provides the user and the input sub-operator with a list of various options such as: to archive indefinitely a copy of the SMP; to store for a specific period the CNP; or to store a log of the delivery confirmation for a period of time along with an electronic certificate of delivery. Document preservation and security preferences B155 records the users generic preferences in the appropriate user (B114) or sub-operator (B124) database.

Client or recipient discount routine B156 provides the user and the input sub-operator with a list of various options that would allow recipients to accept payment from designated categories of message senders and that would allow senders to determine if special discount may apply to their situation. Client or recipient discount routine B156 records the user's generic preferences in the appropriate user (B114) or sub-operator database (B124).

Registration confirmation routine B157 has separate modules of confirmation to individual users and to sub-operators. If registration confirmation routine B157 is processing an individual user, it (a) provides the user a unique id and password, and (b) provides list of available wizard software programs and manuals available, as well as the options for receiving each wizard or manual. For each wizard or manual requested registration confirmation routine B157 arranges, if the registration is via the internet, for a download at A110 or generates an internal message request to internal message generator C150, and then returns control to the user or the staff interviewer at the input sub-operator.

In processing a sub-operator output registration confirmation routine, B157 (a) provides the sub-operator with a unique id and password for the business unit and all staff with access to the system; (b) downloads sub-operator client interfaces, output management software, output communication software, status of account wizard and provides list of other available wizard software programs; (c) confirms the update to sub-operator database B124 regarding payment, settlement, output capacity information and wizard information as appropriate; (d) creates entries in daily registration transaction log B159; and finally (e) returns control to user or staff interviewer at the input sub-operator.

In processing a sub-operator input registration confirmation routine, B157 provides the same tasks as for the sub-operator output above except that at step (c) it downloads a different sub-operator/client interface, input management software, and input operator communication software.

Registration incomplete routine B158 has two modules. If the registration is interactive or there is a telephone registration, registration incomplete routine B158 requests the necessary information. If not, registration incomplete routine B158 (a) prepares a SMP addressed to the user containing a report on difficulties (b) forwards this to internal message generator C150; (c) updates the user database (B114) with a report of the pending difficulties and (d) creates the appropriate entry in daily registration transaction log B 159.

2. B200—Financial System: Pricing Module

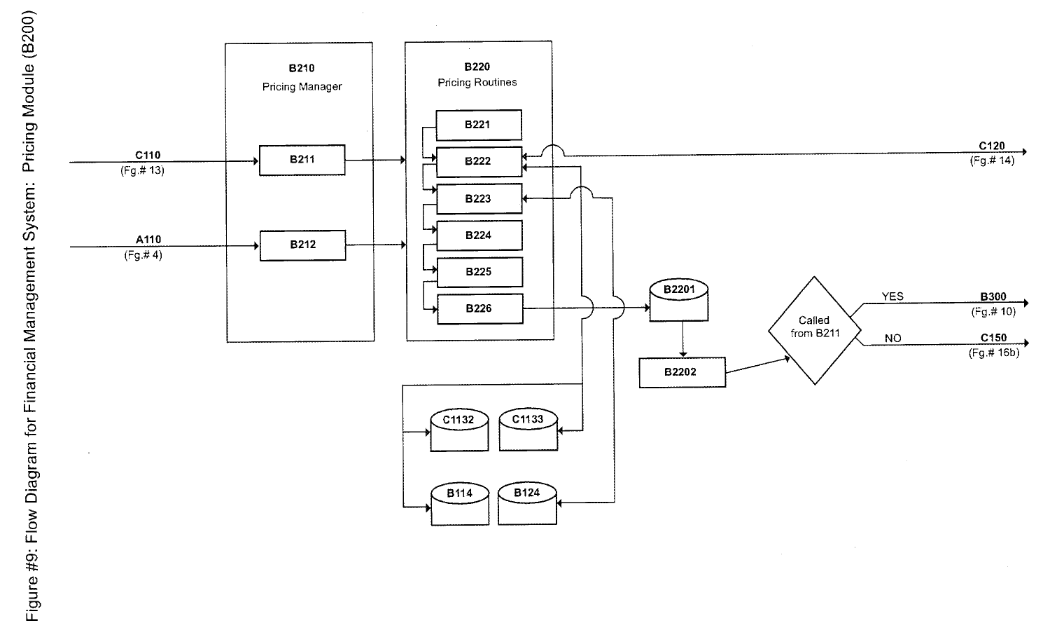

The pricing module B200 of the financial system (see FIG. 9) has a pricing manager B210 and a series of pricing routines B220. The pricing manager B210 has an actual pricing component B211 and a price estimate component B212.

On receipt of an SMP from format checking module C110, actual pricing component B211(a) calls pricing routine B220, (b) edits the CNS to include cost and sub-operator(s) codes in an appropriately marked SGML-type fields; (c) records summary in costing status log B227 and (d) transfers the SMP and control to payment collection section B300.

On receipt of an SMP for costing estimate query from email-origination message A200, letter origination message A200, fax origination message A300, restricted access internal communication system message A400, or telephone/audio origination message A500, price estimate component B212 (a) calls pricing routines B220; (b) records summary in the costing status log B227; (c) prepares the message body of a reply to the query based on the results of the pricing routines B2202; (d) determines the communication system used for estimate query; and (e) generates an internal message request to internal message generator C150.

Pricing routine B220 contains modules that determine price based on the sequential processing of input message pricing routine B221, the output message pricing routine B222, the availability of client discounts routine B223; the user requests for document preservation pricing routine B224, routine for the overhead appropriate to the sub-operators and operator B225. On completion of all these routines, pricing routine B220 totals all the components of the price at B226 and transfers the result as well as control to costing status log at B227.

The input message-pricing module B221 reads input format from CNS of SMP. If the input format was via an input sub-operator in fax form, input message-pricing module B221 determines the total input fax related costs. If the input format was via a telephone service in audio form (telephone call), input message-pricing module B221 determines the total audio input related costs. If the input format was from a restricted access internal communication system (e.g. an internal message system), input message-pricing module B221 determines total internal message system input related costs. For letter originating messages via an input sub-operator, input message-pricing module B221 calculates the scanner-related and transmission costs and then total all input related costs.

The output message-pricing module B222 reads the requested output format <outputformat> on the CNS. If the output request format is a printed letter, output message-pricing module B222 determines message specific costs based on (a) letter format requested (e.g. business/personal); (b) use of headers, footers, and logos; (c) requested special print factors (e.g. size of fonts); (d) print priority code to see if discounts apply; (e) the number of final output pages per output message. Output message-pricing module B222 then determines final delivery costs based on location indicator and information in inventory of output capacities C120 regarding nearest appropriate output center; and calculates postal or direct letter delivery charges using country-postal code database C1131. Output message-pricing module B222 also reads the mail merge counter. If the mail merge counter is greater than 1, the unit costs are multiplied appropriately. Output message-pricing module B222 then totals all output related prices.

If the output request format is an email, output message-pricing module B222 determines total email output related costs.

If the output request format is a fax output message-pricing module B222 undertakes the same steps as for outputting a letter except it (a) reads the final telephone country and area code (b) reads the appropriate routing information from country—telephone code databases C1132; (c) checks the inventory of output capacities C1120 for the nearest appropriate output center; (d) reads the mail merge counter and determines the total number of fax output pages, (e) calculates telephone communication charges; and (f) determines total fax output related costs.

If the output request format is a phone call, output message-pricing module B222 (a) reads the final telephone country and area code (b) reads the appropriate routing information from country—telephone code databases C1132; (c) checks the inventory of output capacities C120 for the nearest appropriate output center; (d) calculates telephone communication charges; (e) determines the number of words for the voice synthesizer; and (f) totals all audio output costs.

If the output requested system is a restricted access internal communication system, output message-pricing module B222 determines total charges, if any, applicable to the restricted access internal communication system.

In the client discounts module B223, sender id<scontactid> and recipient id<rcontactid> are read and any agreed client or recipient discounts using user database B114 or sub-operator database B124. In the document preservation-pricing module B224, appropriate supplemental costs for selected document preservation and security options are determined. In the overhead pricing module B225, sub-operator(s) and operator's margins, and the licensing fee(s) are calculated.

In the final module of the pricing routine, B226, (a) aggregates all the prior sub-totals are (b) records with the message id, the <sontactid> and, if appropriate, the sub-operator's id the costing status log B227 and (c) logs in the input sub-operator's trust account the total of input-related costs from B221, the agreed commissions and discounts from the sub-operator database B124.

3. B300—Financial System: Payment Collection Module

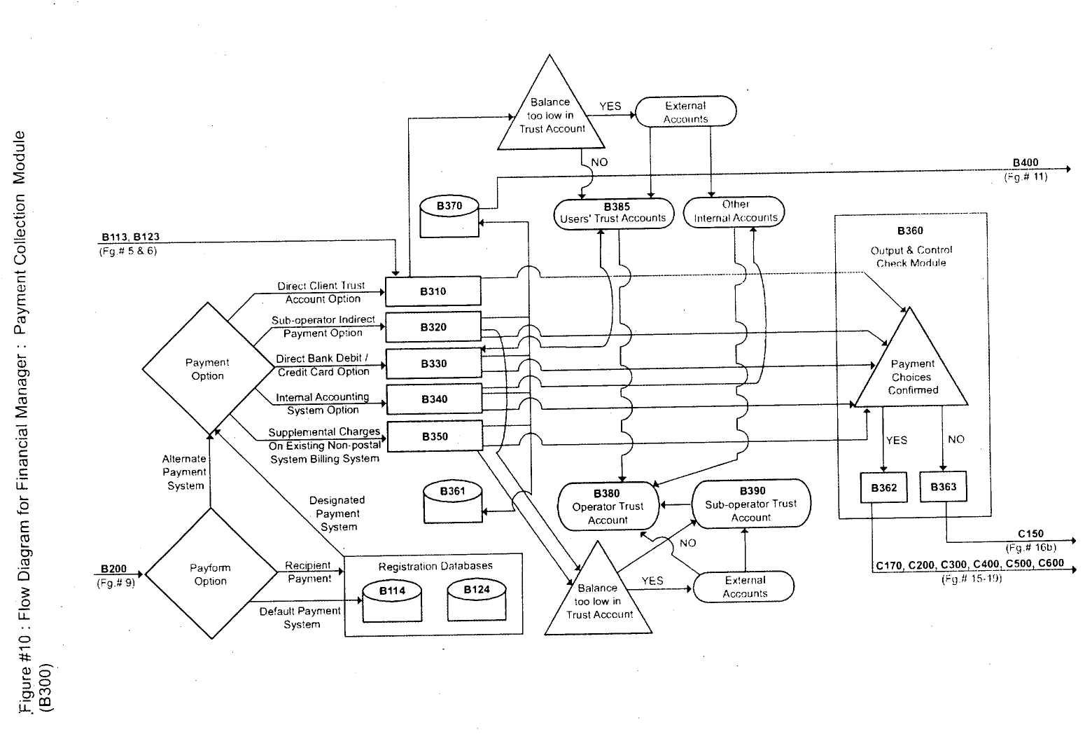

The payment collection module B300 (see FIG. 10) maintains interconnection with the direct client trust account option B310, the sub-operator indirect payment option B320, the direct bank debit/credit card option B330, the internal accounting system option B340, the supplemental charges on existing non-postal system billing system B350, and the audit and supervisor module B360.

On receipt of an SMP from pricing module B200, payment collection module B300 (a) checks if<payform> designates (i) the default financial arrangements in the user database B114 and/or sub-operator database B124, (ii) an alternate payment system; or (iii) payment by recipient as pre-arranged and recorded in the user database B114 or the sub-operator database B124 and (b) transfers control to the appropriate routine of routines B310, B320, B330, B340 or B350 below.

The direct client trust account option B310 (a) forwards to the user trust account specified in CNS a withdrawal request (b) logs a request for withdrawal to audit trust account database B361; (c) receives confirmation of transfer of funds to operator trust account B380; (d) if the balance in user account drops below an agreed amount, arranges to transfer an agreed amount to user trust account B385; (e) transfers payment from user trust account to operator's trust account B390; (f) logs transaction information in financial payment database B370; (g) logs completed action to audit trust account database B361; and (h) transfers control to output and control check module B360.

If a sub-operator has requested to withdraw from the system in B123, the direct client trust account routine makes arrangements are made for a refund(s) and re-turns control to the calling routine B123.

The sub-operator in-direct payment option B320 functions the same as direct client trust account option B310 except that in step (a) forwards to the sub-operator trust account B390 specified in CNS a withdrawal invoice; and in step (d) if the balance in the sub-operator account drops below an agreed amount, arranges to transfer the agreed amount to the appropriate sub-operator's trust account B380.

The direct bank debit/credit card charge option B330 functions the same as direct client trust account option B310 except that in step (a) forwards to the appropriate bank or credit card service a withdrawal invoice, and in step (d) is null.

The internal account charge option (e.g. a government or corporate internal charge line) B340 functions the same as direct client trust account option B310 except that in step (a) forwards to the appropriate internal accounting system a charge request; and step (d) is null.

The supplemental charges on existing non-postal system billing procedures (e.g. the telephone system) B350 functions the same as direct client trust account option B310 except that in step (a) forwards to the appropriate internal accounting system a charge request and step (d) is null.

Output and control check module B360 of the payment collection system records the status of all transactions. Output and control check module B360 maintains the payment collection log B361 for all actions taken by B310 through B350. If all payment data is confirmed, B362 (a) assigns a confirmation code and adds its value to <paymentcd> in the CNS, (b) reads designated output format <outputformat>, and (c) directs SMP to modules C170 to C600, as appropriate. If the payment data is not confirmed, B363 generates a message body for an explanatory SMP to the user and transfers control to internal message generator C150 for transmission of a status message according to the sender's original input format.

4. B400—Financial System: Settlement Section

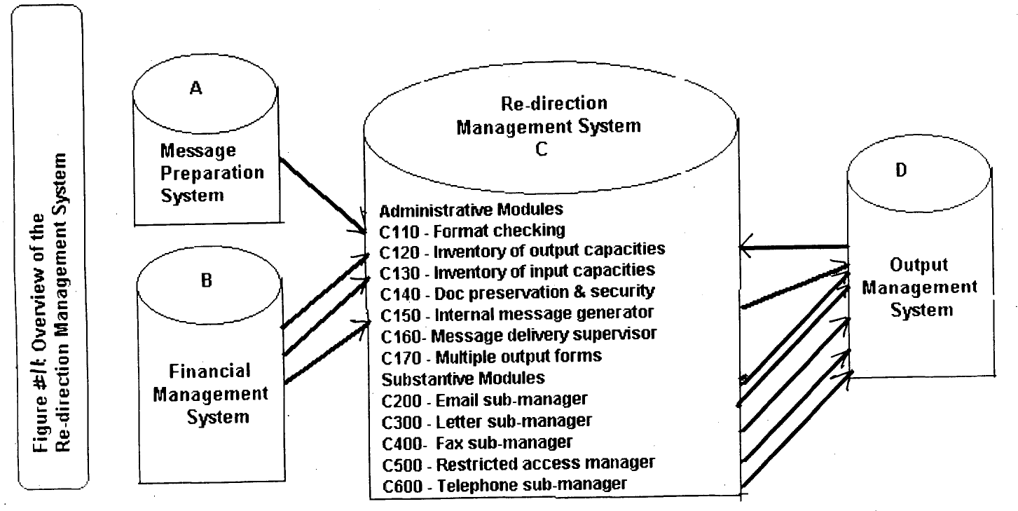

The settlement with operators and sub-operators module B400 of the financial system (see FIG. 11) maintains routines for operators and sub-operators B410, routines relevant to individual users B420, and an interface procedure for real time status reports B430.

For operators and sub-operators routine B410, B411(a) logs hourly (or other periodic basis) all electronic invoices from output sub-operators (D231, D341, D431, D531, or D631, as the case may be) to the appropriate sub-operator's trust account and (b) updates the settlement audit log B418; B412 logs hourly (or other periodic basis) all transfers into operator's trust account from input sub-operators' trust accounts; B413 (a) pays daily (or other periodic basis) electronic bills from operator's trust account to accounts of output operators as specified in sub-operators database B124 based on the current balance in the output operator's trust account and (b) zeros the balance in the output operator's trust account; B414 (a) pays daily (or other periodic basis) electronic bills from operator's trust account to the accounts of the input sub-operators as specified in the sub-operator database B124 and (b) zeros the balance in the output operator's trust account; B415 transfers at end-of-day (or other periodic basis) net balance from the owner's trust account to owner's accounts and B416 (a) generates on a monthly (or other periodic basis) an account statement for the operator, all sub-operators, and internal auditing systems and (b) forwards the account statement as a SMP to internal message generator C150.

If a user or sub-operator has requested to withdraw from the system in B113, B123, or B1133, B417 makes arrangements for a refund(s), generates a action report as a SMP to C150 and returns control to the calling routine B123.

For individual users routine, B420 manages individual pre-financial and pre-authorization accounts and generates on a monthly (or other periodic basis) an account statement for all sub-operators, individual users, and/or internal auditing systems and transmits the statement to the user via internal message generator C150.

Interface procedure for real time status reports B430 permits users based on information in the user database B114 and sub-operator database B124 to have on-line access to the information above.

C—Re-Direct Manager System

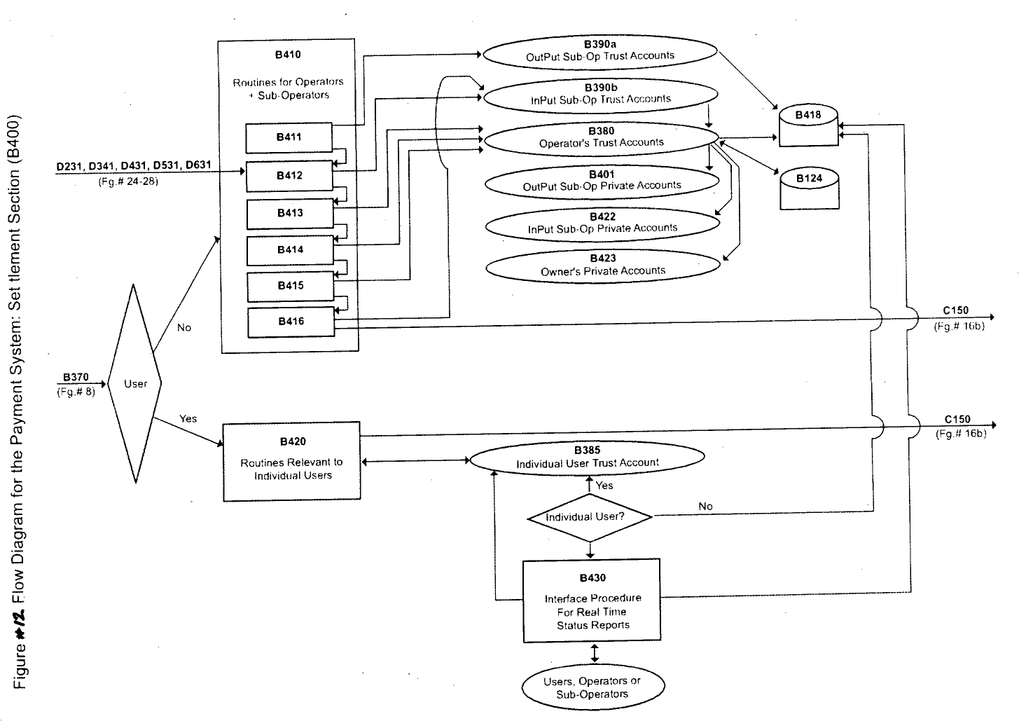

The re-direct manager system C100 (see FIG. 12) consists of a series of administrative modules; a format checking module C110; a manager of the inventory of output capacities module C120; a manager of the inventory of input capacities module C130; a manager of the inventory for documentation preservation and security module C140; a internal message generator module C150; a status of message delivery and accounts supervisor module C160; a source database administrator C170 and a manager of combination and sequential delivery requests module C180;—and a series of substantive modules—an email sub-manager C200; a letter output sub-manager C300; a fax format sub-manager C400; telephone/audio system sub-manger C500; and a restricted access internal communication message sub-manager C600.

Outgoing messages to be distributed thorough other electronic message communication system formats, such as the CEN hybrid mail language standard ENV 14014:2001, may be converted by a one of the processes above into input for that particular other electronic message communication format.

The implementation of this patent is based on existing hardware that is or functions similarly to a personal or a mainframe computer with internet and/or intranet connections, the hardware behind the internet itself, printers (mostly high speed) linked to a computer or an supported by a computer net, and computer storage disks or related storage technologies. The implementation of this patent is based on existing software that is or functions similarly to existing computer operating systems, email software, word processing software, graphic software, Internet and intranet software, file and file security software, as well as various hardware device drivers.

1. C110—Re-Direct Manager System: Format Checking Module

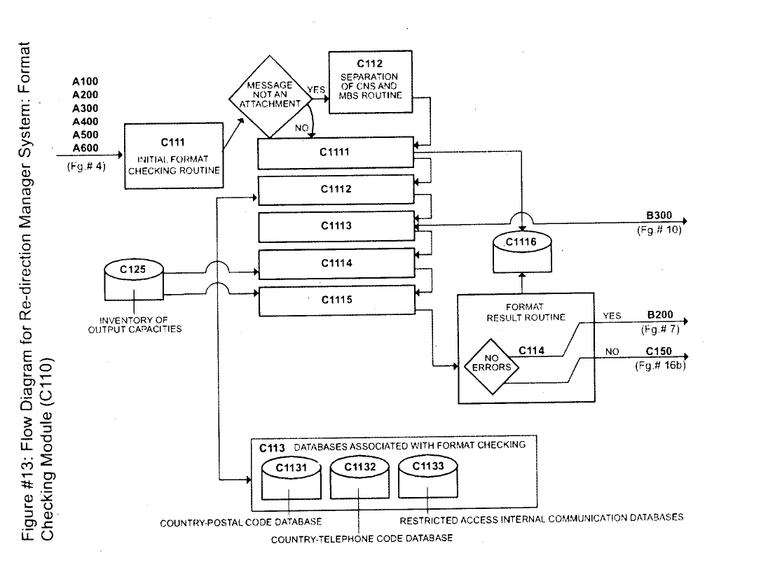

The format checking module C110 of the redirection manager system C100 (see FIG. 13) has routines that check the structure, the syntax, and the variables of the standardized message package at C111; that separates the CNS from MBS at C112; that maintains a series of associated re-direction databases at C113 and that reports the status of the format checking at C114. The sender's use of compression/decompression software and encryption software could also be verified by the format checking module.

On receiving a SMP from a sender or an input sub-operator, the format checking routine C111 undertakes an examination (a) of the structure of the SMP at C1111; (b) of the “re-line” in the SMP at C1112; (c) of the required “SGML-defined tags” in the CNS of SMP at C1113; (d) of the optional “supplement codes” in the CNS of the SMP at C1114; and (e) of the attachment(s) containing the message body in the SMP at C1115.

The examination of the structure of the SMP at C1111 includes, for an email, reading the “indicator of the location of the body of the message”<msglocation> and, if the indicator designates that the body of the message is not in an attachment, then use of separation routine C112 below; otherwise no action. For input as a scanned letter, fax, or from a restricted access internal communication system, C1111 also calls message separation routine C112 below. C1111 also (a) checks the consistency of the attachment suffixes with their software and the acceptability of the files to the email system; (b) checks the completeness of the information on the CNS of the SMP; (c) inserts in CNS the input format of the original message <inputformat> and the contact information for sender <scontactid> or sub-operator <subopid>; (d) calculates the number of output ‘pages’ and records that information in<output len> in the CNS; and (e) assigns a unique id to the incoming email <msgid>, records the <msgid> in the CNS and in the message id log file at C1116.

The examination of the <relind> in the CNS at C1112 includes (a) checking that one of the approved unique identifiers of the recipient address exist and that their values are valid utilizing the associated re-direction databases C113 below. If a restricted access internal communication system code is provided and that system is time dependent, C1112 checks that the designated recipient is scheduled to be in contact with the owner/manager of restricted access internal communication system within a specified period of time (e.g. has a pending airline reservation).

The examination of the required “SGML-defined tags” in the CNS of SMP at C1113 includes (a) checking that the minimum required SGML-type codes exist and are complete; (b) checking the availability of suitable output devices using inventory of output capacities C125; (c) checking that the payment code(s)<payform> and <paypersonid> are valid and, if appropriate, that the account has a positive balance, using payment collection module B300; (d) checking an output dependent information is available and confirms with required status (e.g. a letter output format has the proper postal information) that conforms with the standards in the C113 set of re-direction databases (see below).

The examination of the optional “supplement codes” in the CNS of the SMP at C1114 includes (a) checking that complementary SGML, XML or HTML codes are valid and appropriate to the designated output format and device, using inventory of output capacities C125.

The examination of the attachment(s) in the SMP at C1115 includes (a) checking that all message attachments can be launched by their respective software packages; (b) checking, when necessary, that the internal names <rlistname> in the CNS match the attachment names; and (c) confirming that the attachments can be transmitted by the designated output devices, using inventory of output capacities C120 and (d) checking that only approved SGML-type and related codes are used in the message body attachments.

The separation of CNS and MBS of the format checking module C112 (a) extracts the body of the message from the body of the email (b) copies it to a word processing file; (c) saves it as a word processing document; (d) extracts the CNS of the SMP; (e) creates a new SMP with the CNS in the email itself and the new word processing document as an attachment; (e) deletes the word processing document file and the original SMP; and (f) returns revised SMP to the subsequent steps of the format checking module C1111.

Re-direction databases C113 that are associated with the format checking module C1112 include (a) a country—postal code database including approved address templates and postal charge schedule within local area at C1131; (b) a country-telephone code databases including approved telephone code templates, telephone routine numbers from local area, and telephone charges to local area at C1132; and (c) restricted access internal communication system databases including approved format for unique identifiers in each such system at C1133.

The format result routine C114 determines that if there are no errors, then it (a) records the status from C1111 to C115 in the message id log file at C1116; (b) adds the unique id <msgid> to the CNS; and (c) transfers control to pricing module B200; otherwise format result routine C114 generates an internal message to internal message generation module C150 in the format of the original message to the sender or the sub-operator with an explanation of the errors and/or unavailable requested options, a recommendation for appropriate corrections, and records the status in message id log file at C1116.

2. C120—Re-Direct Manager System: Manager of the Inventory of Output Capacities

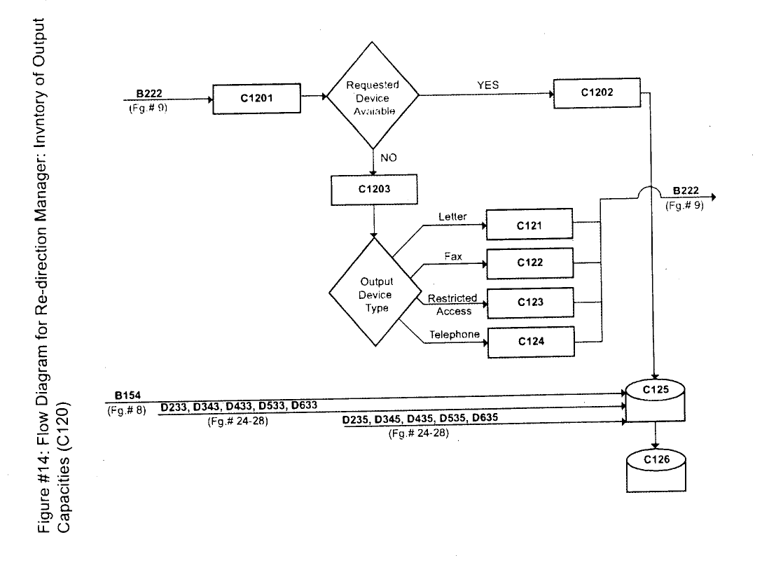

Using input received from output capacities inventory routine B154, the manager of the inventory of output capacities C120 (see FIG. 14) creates or modifies an entry in the output capacities database C125 and creates a output capacity log entry for any changes in C126. Modifications include any scheduled or unscheduled maintenance/shutdown of an output device of a sub-operator's service.

Using queries from pricing module B222, the manager of the inventory of output capacities C120 (a) confirms the availability of requested output devices at C1201. If the requested output device is available, manager of the inventory of output capacities C120 would provisionally book (for a specified period of time) a portion of the output device capacity at C1202; otherwise C1203 would call C121 to C125 (as appropriate) to provide pricing module B200 with a recommendation for a secondary output device.

The postcode to output center C121 manages support databases, combining relevant portions of the inventory of output capacities and geographic information on postcodes. Postcode to output center C121 would at least include a postal code to output center email address database that returns the email address of nearest local output sub-operator with the appropriate postal printing devices, given the requirements in the SGML-type code and the available print capacity.

The faxcode to output center C122 manages support databases, combining relevant portions of the inventory of output capacities and geographic data on telephone codes. Faxcode to output center C122 would at least include a telephone code to output center email address database that returns the email address of nearest local output sub-operator with the appropriate fax generating output capacity, given the requirements in the SGML-type code and available fax capacity.

The non-postal to user id database C123 manages support files, combining relevant portions of the inventory of output capacities and relevant linking records to the restricted access communication. Non postal to user id C123 would at least include a restricted access internal communication system unique user id with the next most recent scheduled encounter on the restricted access internal communication system with the individual designated user within the designated time before the scheduled encounter (e.g. 2 hours before departure).

The telcode to output databaser C124 manages support files, combining relevant portions of the inventory of output capacities and geographic information on telephone code areas. Telcode to output center C124 consists of at least a database that links languages to capacities of various voice synthesizers and (b) telephone code to output center email address database that returns the email address of the nearest local output sub-operator with the appropriate voice synthesis generating output capacity, given the requirements in the HTML and XML type code and available capacity.

Using messages generated from the D235, D335, D435, D535, D635, the manager of the inventory of output capacities C120 logs current demand and capacity status on a near real time (or other periodic) basis for each output device in C125 and creates a log entry in output capacity log C126. C125 can also be “manually” revised by an output sub-operator using D235, D345, D435, D535, or D536.

3. C130—Re-Direct Manager System: Manager of the Inventory of Input Capacities

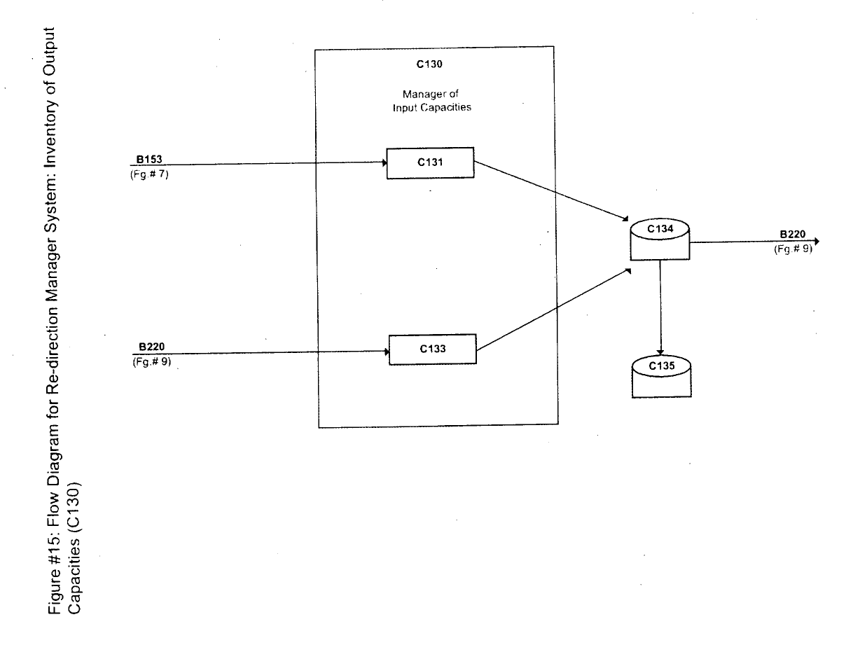

Using input received from input capacities routines B153, the manager of the inventory of input capacities C131 (see FIG. 15) creates or modifies an entry in the input capacities database C134 and creates a input capacity log entry for any change in C135. Modifications include any scheduled or unscheduled maintenance of an input device, or scheduled or unscheduled shutdown of a sub-operator's service. Using queries from pricing module B220, manager of the inventory of input capacities C133 would provide any input device costing information.

4. C140—Re-Direct Manager System: Inventory of Document Preservation and Security Options

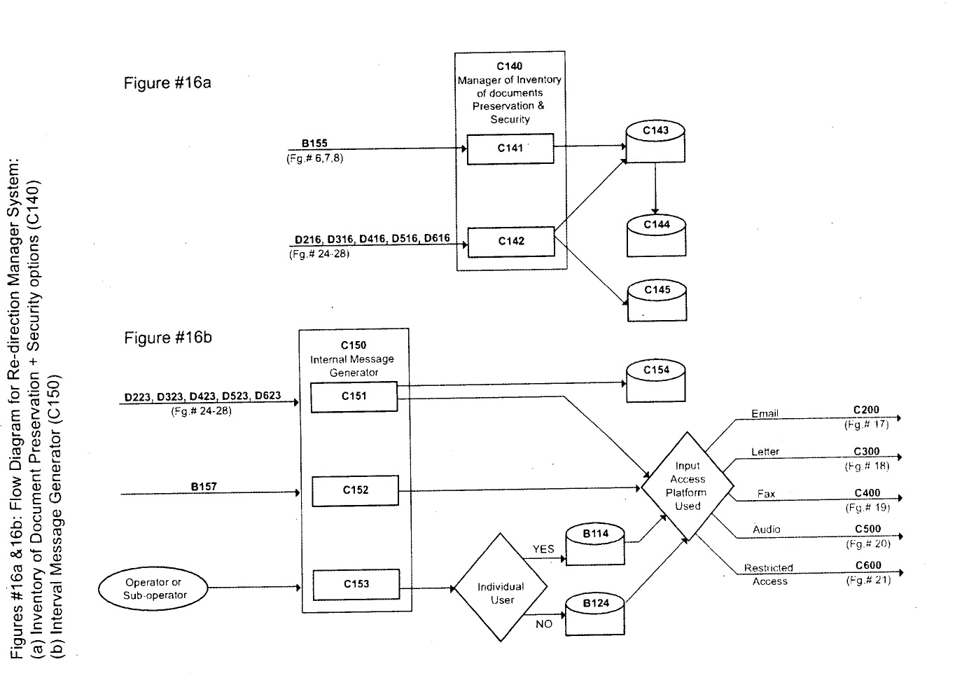

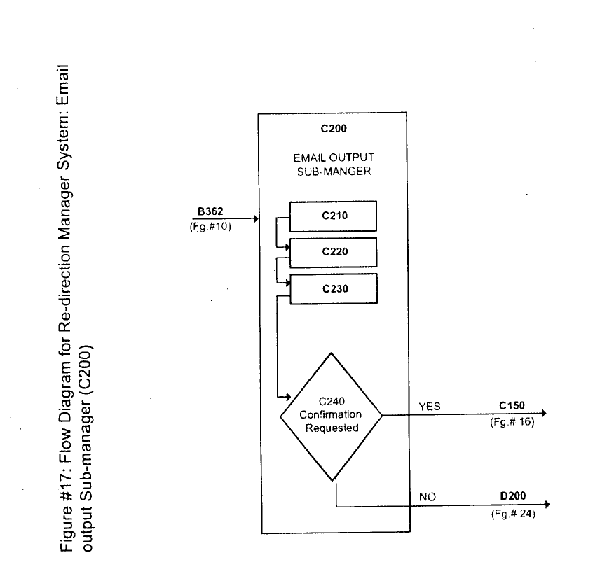

Using input received from user registration module of the financial system B155, the manager of the inventory of document preservation and security C141 (see FIG. 16A) (a) creates or modifies an entry in the documents preservation database C143 and (b) creates a preservation/security log entry for any action taken at C144.

Using input received from D215, D315, D415, D515, or D516, the manager of the inventory of document preservation and security C142 (a) updates the entry in the documents preservation database C143 confirming transmission and/or delivery; (b) assigns a storage id to the message package and add a second date stamp to the CNS; (c) transfers the entire SMP to a long-term storage device(s) at C145; (d) records in the documents preservation database C143 the access point in the long-term storage device(s).

5. C150—Re-Direct Manager System: Internal Message Generator

Using input received from other parts of this cross-platform transmission message system, this internal message generator C150 of the re-direct manager system (see FIG. 16B) (a) creates an SMP with the CNS derived from the incoming message and MBS containing the appropriate explanatory information at C151; (b) creates an internal message log entry for each internally generated message at C154; (c) given the input communication system used <inputformat>, transfers control to the appropriate re-direction sub-manager (C200 to C500).

Using input received from registration confirmation routine B157, internal message generator C150 generates an SMP arranging for the distribution of manuals and other related documents at C152. On request from an operator or sub-operator, a SMP can be generated that accesses the user (B114) or sub-operator's (B124) database to send generic messages (e.g. advertising or other announcements) to categories of users of the system at C153.

6. C160—Re-Direct Manager System: Status of Message and Status of Accounts Supervisor

Using log summary reports from all parts of the system (see table #2), the status of message supervisor C160 (a) maintains a database or links between log file(s) containing the status of all messages, actions taken on each message, status of all associated input and output devices, and status of all current sub-operators and (b) operates an access system to allow sub-operators and operators, as appropriate, to view relevant portions of the message logs and associated database(s). Each individual log entry is generally of the standardized form: <msgid>, <subopid>, transaction information, and a date and time stamp.

7. C170—Re-Direct Manager System: Database Source Administrator

The source database administrator C170 (a) maintains the information bank of databases or links between such file(s) containing the registration information, financial flows information, reference files of various configuration (see table #3).

TABLE 2
Log names, designations, locations, association
and read access rights

| | | | Associated | Read |
|---|---|---|---|---|
| Log name | Designation | In FIG. | with | Access by |
| Daily registration | B159 | 6, 7 & 8 | B100 | Operator |
| transaction log | | | | |
| Costing status log | B227 | 9 | B200 | Operator |
| Payment collection | B361 | 10 | B300 | Operator |
| log | | | | |
| Settlement audit log | B418 | 11 | B400 | Operator |
| Message id log | C1116 | 13 | C110 | Operator |
| Output capacity log | C126 | 14 | C120 | Operator and/ |
| | | | | or sub-operator |
| Input capacity log | C135 | 15 | C130 | Operator and/ |
| | | | | or sub-operator |
| Preservation/ | C144 | 16(a) | C140 | Operator |
| security log | | | | |
| Internal message log | C154 | 16(b) | C150 | Operator and/ |
| | | | | or sub-operator |
| Email delivery log | D240 | 24 | D200 | Operator and/ |
| | | | | or sub-operator |
| Output sub-operator | B4419 | 24 | D200 | Operator and/ |
| billing log | | | | or sub-operator |
| Letter delivery log | D340 | 25 | D300 | Operator and/ |
| | | | | or sub-operator |
| Fax delivery log | D440 | 26 | D400 | Operator and/ |
| | | | | or sub-operator |
| Audio delivery log | D540 | 27 | D500 | Operator and/ |
| | | | | or sub-operator |
| Restricted access | D640 | 28 | D600 | Operator and/ |
| delivery log | | | | or sub-operator |

TABLE 3
Database names, designations, locations, association and access rights

| Database name | Designation | In FIG. | Associated with | Access rights |
|---|---|---|---|---|
| user database | B114 | 6, 7, 10 & 16(b) | B110, B120, | Operator and sub- |
| | | | B200, B300, & | operator (rw) |
| | | | C150 | |
| Sub-operator | B124 | 7, 8, 9, 10, | B120, B130, | Same as above |
| database | | 11 & 16(b)&& | B200, B300 & | |
| | | | B400 | |
| audit trust account | B361 | 10 | B300 | Operator and sub- |
| database | | | | operator (read only) |
| financial payment | B370 | 10 | B300 | Same as above |
| database | | | | |
| associated re- | C113 | 13 | C110 | Operator and sub- |
| direction databases | | | | operator (rw) |
| Country-postal code | C1131 | 9 & 13 | B200 & C110 | Same as above |
| database | | | | |
| Country - telephone | C1132 | 9 & 13 | B200 & C110 | Same as above |
| code database | | | | |
| Restricted access | C1133 | 13 | C110 | Same as above |
| format database | | | | |
| input capacity | C134 | 4 & 15 | A110 & C130 | Same as above |
| database | | | | |
| output capacities | C125 | 13, 14, 18, 19, 20 | C110, C120, | Same as above |
| database | | & 21 | C300, C400, | |
| | | | C500 & C600 | |
| postcode to output | C121 | 18 | C300 | Same as above |
| center | | | | |
| Faxcode to output | C122 | 19 & 20 | C400, C500 | Same as above |
| center | | | | |
| non postal to user id | C123 | 21 | C600 | Same as above |
| database | | | | |
| Telcode to output | C124 | | C400 & C500 | Same as above |
| database | | | | |
| Documents | C143 | 16(a) | C140 | Operator (read |
| preservation | | | | only) |
| database | | | | |
| Long term storage | C145 | 16(a) | C140 | Operator (read |
| database | | | | only) |

7. C180—Re-Direct Manager System: Combination And Sequential Delivery Requests

The manager of combination and sequential delivery requests C170 directs any SMP with two or more specified output devices and controls the calls to the appropriate re-direction managers.

8. C200—Re-Direct Manager System: Email Sub-Manger

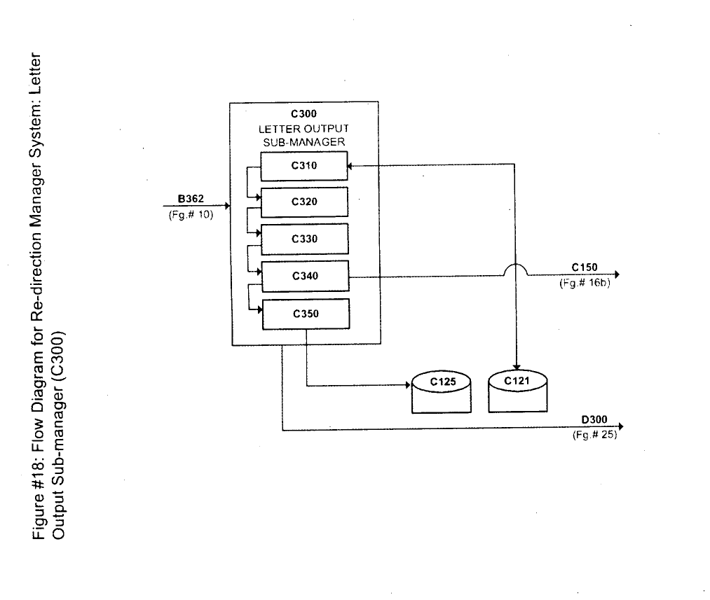

Using input received from payment collection module B363 of the financial management system, the email output sub-manager C200 of the Re-direct manager system (see FIG. 17) (a) at 210 reads the “subject-line” information in the CNS and any SGML, HTML and XML format instructions, (b) at 220 (b) re-formats email by inserting in “to-line”, the email address of the recipient at C220; (c) at C230 re-formats the SMP given the SGML, HTML and XML codes in the original SMP; (d) at C240 (i) if confirmation <msgconfirm> is indicated in CNS, generates a SMP to the C150 internal message generator and (ii) transfers control of the modified SMP to the email message delivery module D200; otherwise only transfers control of the modified SMP to the email message delivery module D200.

9. C300—Re-Direct Manager System: Letter Sub-Manager

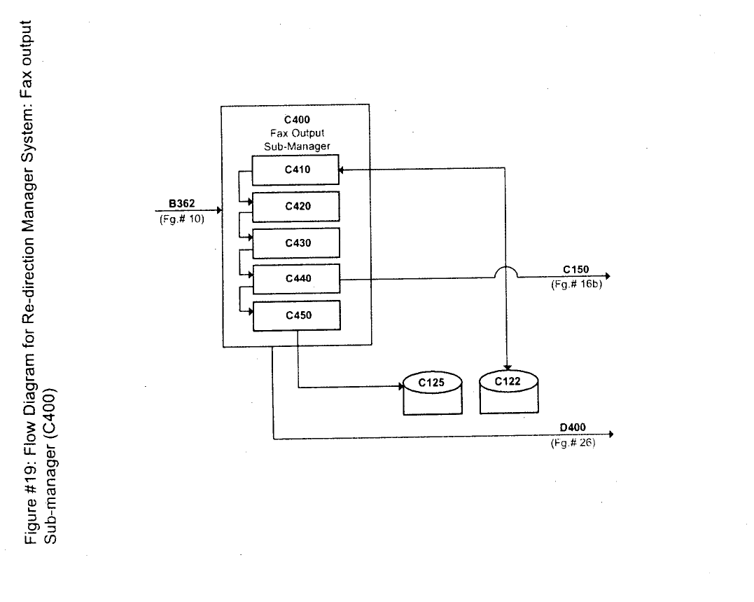

Using input received from payment collection module B363 of the financial management system the letter output sub-manager C300 of the re-direct manager system (see FIG. 18) (a) using the “subject-line” information and any SGML, XML or HTML format instructions, calls postcode to output center C121 to determine the best available output center currently able to process the request at C310; (b) re-formats the email by inserting in “To-line” the email address of appropriate output center at C320; (c) re-format the email by inserting in “subject-line” the “print now” default value or appropriate print priority code at C330; (d) if confirmation is indicated in CNS, generate a SMP to the C150 internal message generator at C340; (e) updates current scheduled demand for the designated output device in manager of the inventory of output devices C120 at C350; and (f) transfers control of SMP to the appropriate sub-operator using letter message delivery module D300.

10. C400—Re-Direct Manager System: Fax Sub-Manger

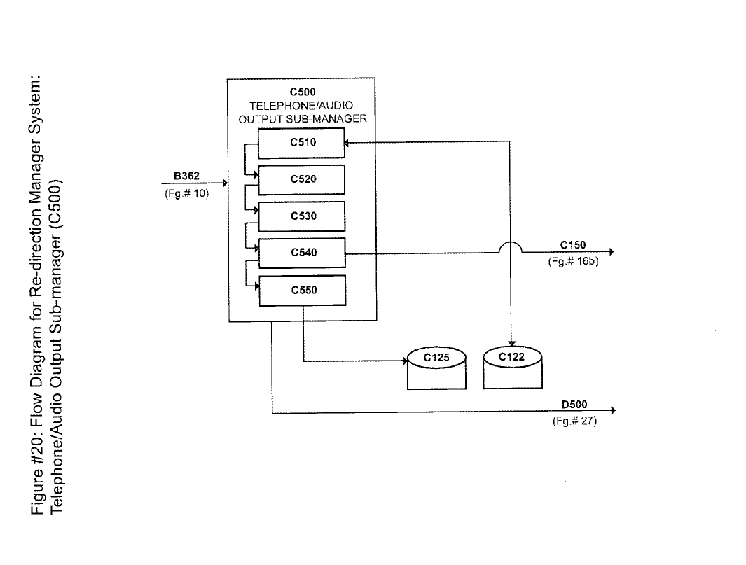

Using input received from payment collection module B363 of the financial management system, the fax format output sub-manager C400 (see FIG. 19) (a) using the “subject-line” information and any SGML, XML or HTML format instructions, calls telcode to output center C122 to determine the best available fax output center currently able to process the request at C410; (b) if the primary fax number is not working, determines the backup fax number from the CNS and re-send at C420; (c) if confirmation is indicated in CNS, generate a SMP to the C150 internal message generator at C440; (d) updates the current scheduled demand for the designated output device in manager of the inventory of output devices C125 at C450; and (e) transfer control of message to the appropriate sub-operator using fax message delivery module D400.

11. C500—Re-Direct Manager System Telephone/Audio Systems Sub-Manager

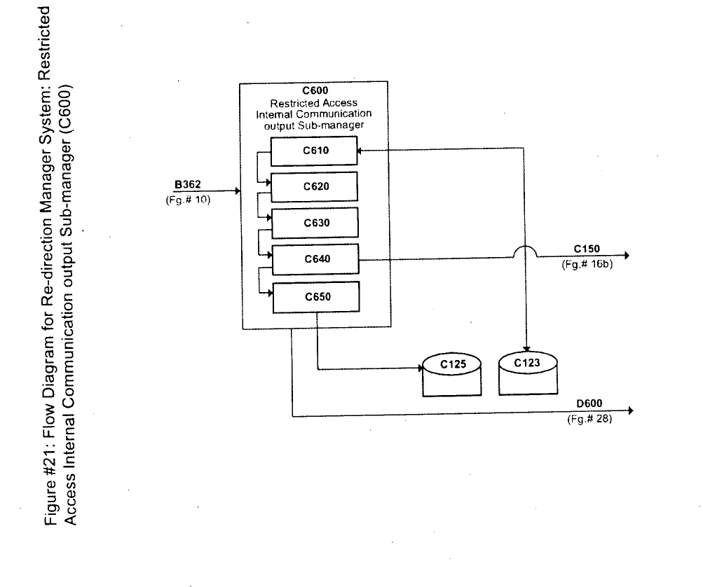

Using input received from payment collection module B363 of the financial management system, the telephone/audio output sub-manager C500 (see FIG. 20) (a) using the “subject-line” information and any SGML, XML or HTML format instructions, calls telcode to output center database C122 at C510; (b) if confirmation is indicated in CNS, generate a SMP to the C150 internal message generator at C540; (c) updates the current scheduled demand for the designated output device in manager of the inventory of output devices C122 at C550 and (d) transfers control of SMP to the appropriate sub-operator with a telephone message delivery module D500.

12. C600—Re-Direct Manager System: Restricted Access Internal Communication Message Sub-Manager

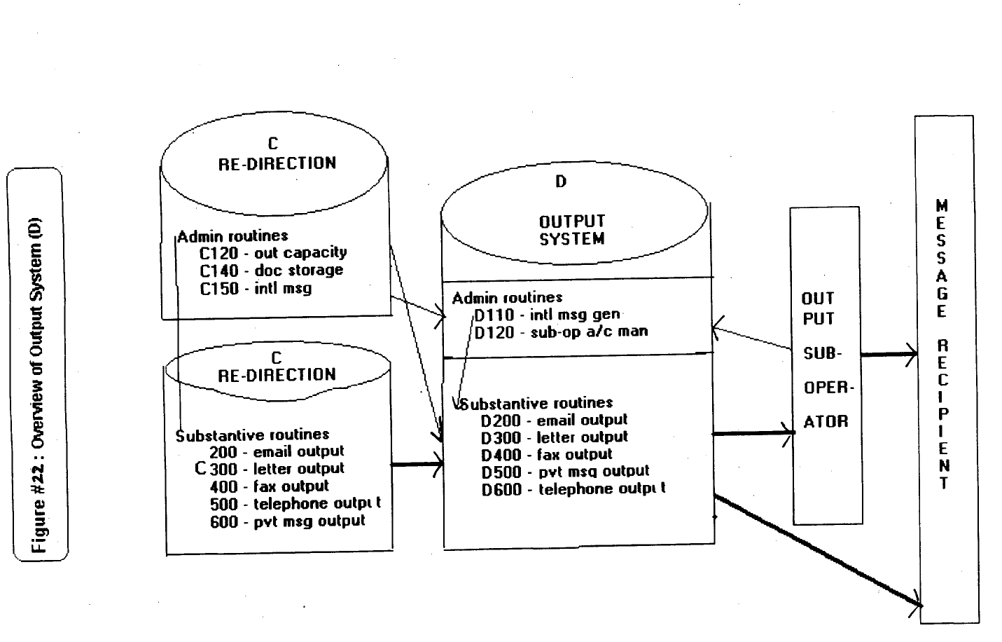

Using input received from payment collection module B363 of the financial management system, the restricted access internal communication message output sub-manager C600 (see FIG. 21) (a) using the “subject-line” information in CNS and the SGML, HTML, or XML codes in the MBS, calls non postal to user id C123 at C610; (b) if confirmation <msgconfirm> is indicated in CNS, generate a SMP to the C150 internal message generator at C640 (b) updates current scheduled demand for the designated output device in manager of the inventory of output devices C125 at C650; and (d) transfers control of message package to the appropriate sub-operator with access to the restricted internal communication message delivery module D600.

D—Message Output System

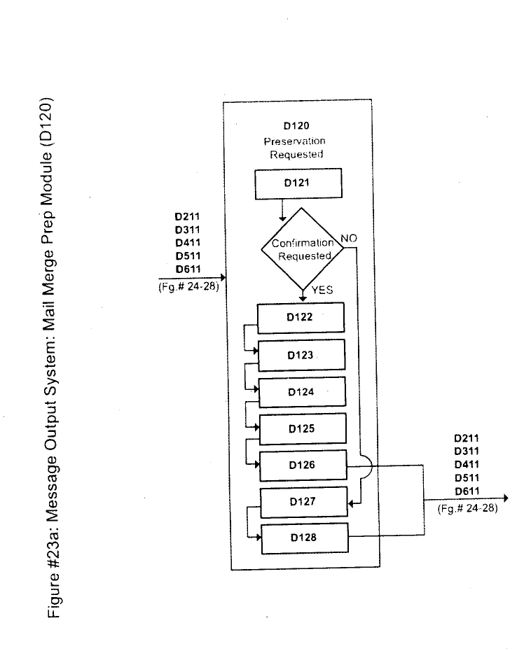

The message output system (see FIG. 22) has an administrative module to multiple a “mail merge” version of SMP D120, to reverse the SMP to the requested output communication system—a mail output software package D130; and to generate financial reports to sub-operators and operators D140. The message output system also has substantive modules for the final output of the message as an email D200; as a letter D300; as a fax D400; as a telephone call D500 and as a message for a restricted access internal communication system D600.

Outgoing messages to be distributed thorough other electronic message communication system formats, such as the CEN hybrid mail language standard ENV 14014:2001, may forwarded by one of the processes above into input for that particular other electronic message communication format.

The implementation of this patent is based on existing hardware that is or functions similarly to a fax machine, a personal computer with internet and/or intranet connections, scanners, the hardware behind the internet itself, printers (mostly high speed) linked to a computer or an supported by a computer net, voice and audio transmission systems, postal franking machines, folding and stuffing equipment, computer storage disks or related storage technologies. The implementation of this patent is based on existing software that is or functions similarly to existing computer operating systems, word processing software, email software, voice and audio software, generalized accounting and billing software, graphic software, internet and intranet software, file and file security software, as well as various hardware device drivers.

1. D120—Message Output System: “Mail Merge” Prep Module

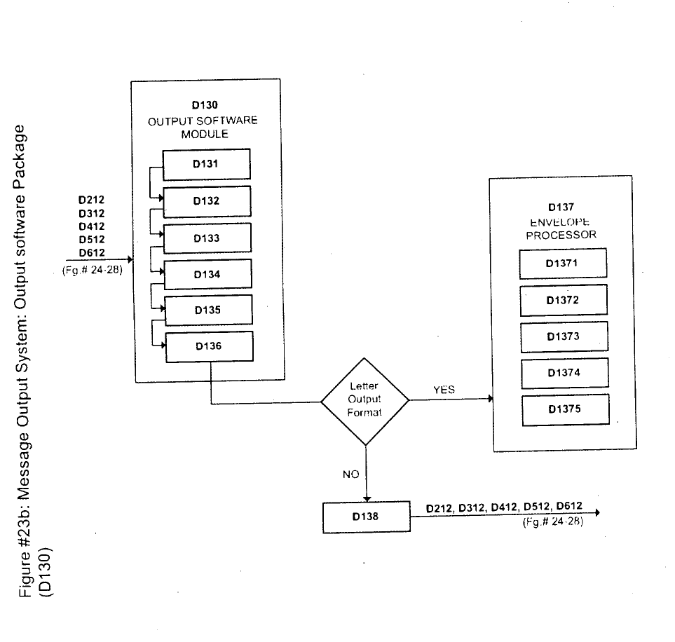

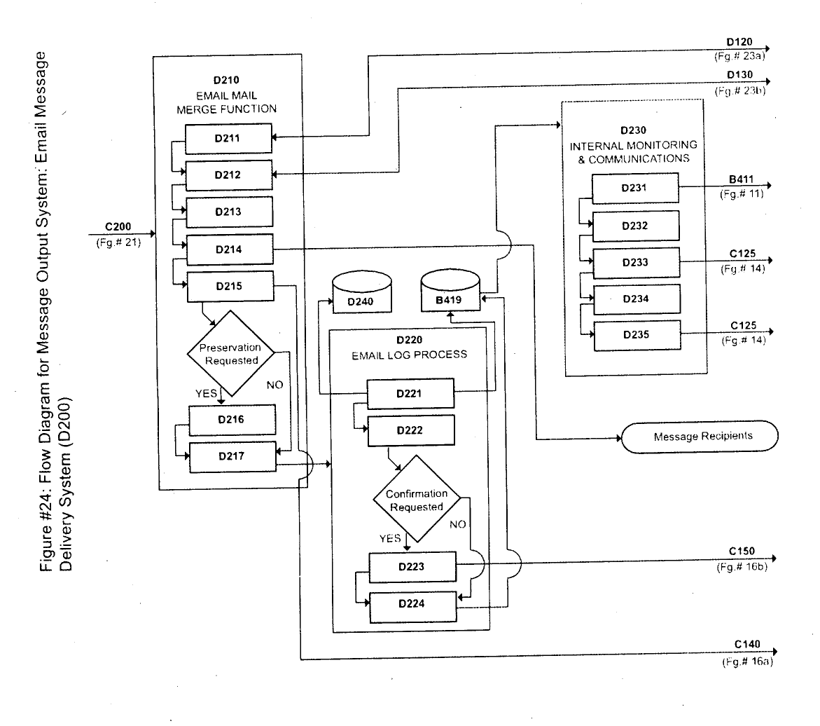

The mail merge preparatory module D120 (see FIG. 23A) has the functions of an email system, a word processor, and a browser, each with macro capabilities. Using input from D211, D311, D411, D511, or D611, mail merge preparatory module D120 (a) reads the count for mail merge <rnamecount> at D121; and if the count for mail merge greater than 1, (b-i) reads from CNS the SGML-type tag with the name of the attachment <rlistname> with the list of contact merge addressees at D122; (c) copies the appropriate attachment containing the MBS to a word processing file at D123; (d) generates the series of final output MBS incorporating the necessary mail merge information at D124; (e) stores them in a temporary buffer at D125; and (f) forwards them sequentially back to the calling routine at D126. If, however, the count for the mail merge <rnamecount>=1, mail merge preparatory module D120 reads, using the SGML-type defined tags in the CNS, the recipient name <rname> and mailing contact information <rcontactid> at D127; and forwards the relevant tags and related information back to the calling routine at D128.

2. D130—Message Output System: Output Software Package

The output software module D130 (see FIG. 23B) has the function of a web browser and a word processor, each of which has macro function capabilities. Using input from D212, D312, D412, D512, or D612, the output software module D130 (a) opens the incoming email in non-visible window at D131; (b) reads key variables from the CNS of the SMP at D132; (c) opens all the printable attachments in dependent non-visible sub-windows at D133; (d) opens an other set of dependent non-visible windows incorporating all the HTML, SGML, XML, format instructions from the CNS of the SMP in the final message layout at D134; (e) directs the contents of this window to the designated output device incorporating with it any special output instructions from the CNS at D135; (f) closes the dependent sub-window and its immediate parent window at D136; (g) if the output communication system <outputformat> is a letter, calls envelope processor D321 at D137; and (h) close this sub-window and returns control to the calling routine at D138.

The envelope processor D137 (a) opens another non-visible window with java script or similar language at D1371; (b) reads all the relevant information for the envelope at D1372; (c) formats in this window with SGML-type code the envelope incorporating all the special print instructions at D1373; (d) directs the printing of the window to the appropriate envelope printer at D1374; and (e) close this sub-window at D1375.

3. D140—Message Output System: Sub-Operator Account Messenger

The sub-operator account message module D140 of the message output system performs the following tasks (a) email daily (on at another periodic basis) billing log entries to the settlement module B411 of the financial system; (b) log incoming statements for the settlement of accounts from settlement module B411 of the financial system; (c) provides daily (or other periodic basis) summaries of billing logs entries and settlement of account information.

4. D200—Message Output System: Email Message Delivery Format

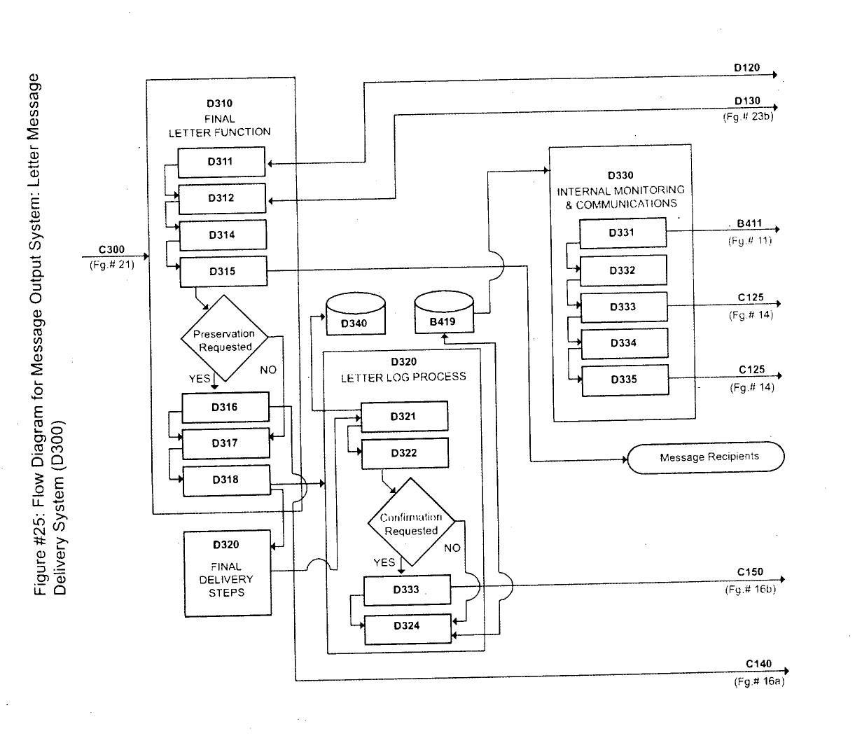

The email message delivery format module D200 (see FIG. 24) has components that re-generate from the SMP the final email message D210, maintain a log of the process D220; and maintain internal monitoring and communication D230.

On receipt of an SMP forwarded by the email sub-manger of the re-direction manager system C200, the email mail merger function D210 (a) calls mail merge processor D120 at D211; (b) calls output software module D130 as many times as indicated by the mail merge counter at D212; (c) attaches or re-attaches any relevant files at D213; (d) sends the properly formatted email to the email recipient at D214; (e) copies the CNS of the SMP to a email transaction log D240 at D215; (f) depending on document preservation option selected by the user (default value in registration databases or <msgsecurity>), forwards the revised SMP to document preservation inventory manager C140 with an appropriate date stamp at D216; and (g) deletes the MBS of SMP from the sub-operator's email system at D217.

The log process D220 (a) generates a email delivery log entry 240 that all tasks are completed at D221; (b) reads from the CNS the request for confirmation of delivery indicator <msgconfirm> at D222 and if confirmation of delivery is requested, generates an SMP to the internal message generator C150 at D223; and (c) generates an email billing log entry B419 itemizing sub-operator's costs and services at D224.

The internal monitoring and communication component D230 performs the following tasks (a) emails daily (or at other periodic basis) letter billing log entries (D2202) to settlement with operators and sub-operators module B400 at D231; (b) determines hourly (or other periodic basis) current output demands, size of email buffers, functioning of all output devices and calculates current capacities at D232; (c) transmits current output demands and capacities to manager of inventory of output capacities C125 at D233; (d) provides access to all operating logs at D234; and (e) provides sub-operator with status message formats to manually update manager of inventory of output capacities C125, including future scheduled maintenance activities on output related devices at D235.

5. D300—Message Output System: Letter Message Delivery Format

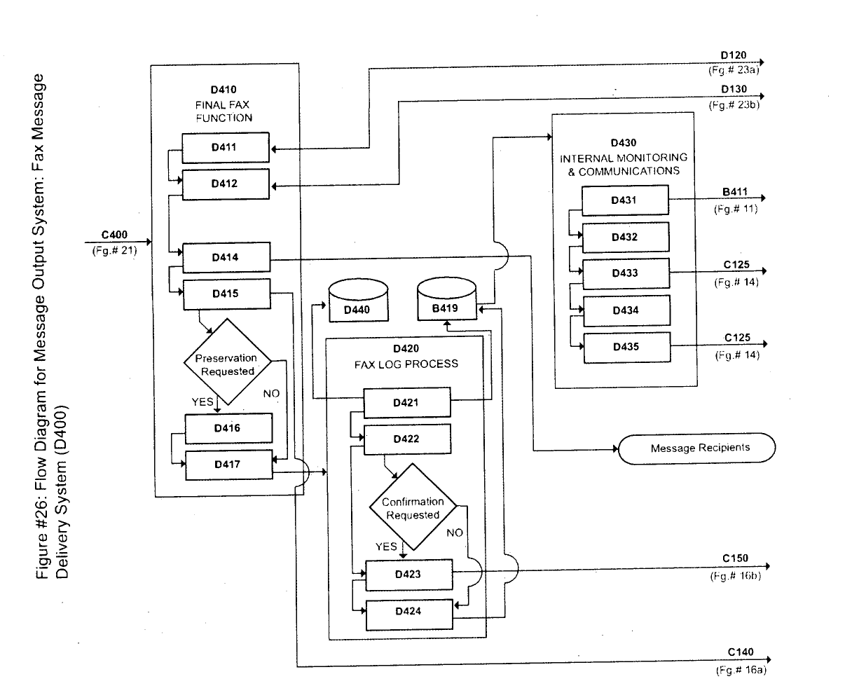

The letter message delivery format module D300 (see FIG. 25) has components that re-generate from the SMP the final letter message D310, control the final letter delivery step D320, maintain a log of the process D330; and maintain internal monitoring and communication D340.

On the receipt of an SMP forwarded by the letter sub-manger of the re-direct manager system C300, the final letter function D310 functions similarly to email merger function D210 except that step (c) is omitted; step (d) sends the output to a printer controlled by mail output software and a final step calls final delivery steps D320.

Final Delivery Steps D320 (a) prints the address of the recipient <rcontactid> and the sender's return address (<scontactid> unless <sreturnaddress2> is not null); (b) folds the letter appropriately; (c) inserts the letter into the envelope; (d) seals the envelope; (e) reads the final delivery mechanism option from the CNS such that if the delivery mechanism is the postal service, franks the envelope appropriately and delivers it to a postal service; if the delivery mechanism is a door-to-door service, delivers it to the door-to-door service; and if the delivery mechanism to collection from the output sub-operator, files appropriately and holds it for collection.

The log process D330 functions identically to log process D220.

The internal monitoring and communication component D340 functions identically to internal monitoring and communication component D230 except that step (b) would monitor the status of the print and envelope buffers.

6. D400—Message Output System: Fax Message Delivery Format

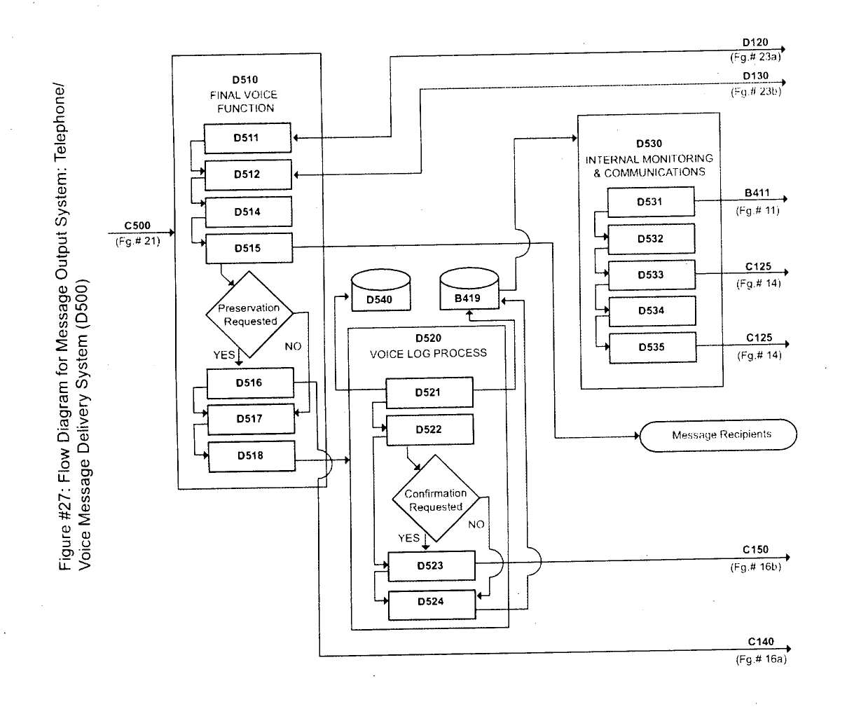

The fax message delivery format module D400 (see FIG. 26) has components that re-generate from the SMP the final fax message D410, undertake some final fax stages D420; maintain a log of the process D430; and maintain internal monitoring and communication D440.

On receipt of an SMP forwarded by the fax sub-manger of the re-direct manager system C330, the final letter function D410 functions similarly to email merger function D210 except that step (a) also generates from CNS a fax cover sheet; step (b) adds the fax cover sheet to the final fax message; step (c) is omitted; and step (d) sends the output to a fax software controlled by mail output software and a final step calls final delivery steps D420.

The fax final stages D420 (a) sends the fax message and (b) if the fax telephone number is non operable, tries the optional backup telephone number.

The log process D430 functions identically to log process D220.

The internal monitoring and communication component D440 functions identically to internal monitoring and communication component D230 except that step (b) monitors the status of the print and envelope buffers.

7. D500—Message Output System: Telephone Message Delivery Format

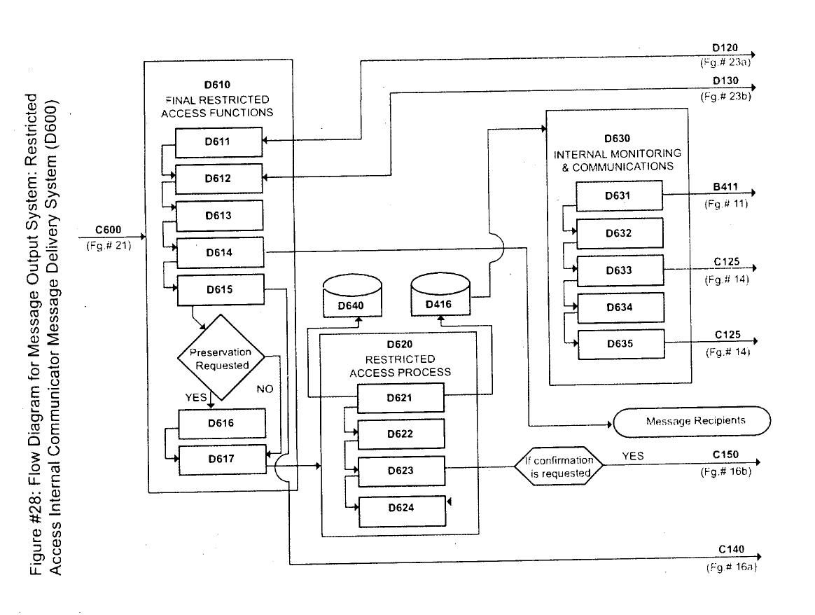

The telephone message delivery format module D500 (see FIG. 27) has components that generate voice messages for multiple recipients B510; generate voice/telephone output D520; maintain a log of the process D530; and maintain internal monitoring and communication D540.

On receipt of an SMP forwarded by the telephone sub-manger of the re-direct manager system C600, the final voice mail function D510 functions similarly to the final email function D210 except that step (c) is omitted; and a final voice delivery step D518 (a) formats the voice mails in the requested design; (b) dials the primary telephone number; (c) enquires for the addressee and (d) when the addressee replies with the appropriate key, uses a voice synthesizer to output the voice mail to the recipient. If the addressee is not available, D518 leaves (a) an answering message or (b) voice message that a voice message package is available and provides the sub-operator's telephone and the unique id for the SMP.

The log process D530 functions identically to log process D220.

The internal monitoring and communication component D530 functions identically to the internal monitoring and communication component D230 except that step (b) at D532 determines hourly (or other periodic basis) the size of available voice mail buffers.

8. D600—Message Output System: Restricted Access Internal Communication Messaging Systems

The restricted access internal communication message delivery module D600 (see FIG. 28) has components that generate voice/telephone output D610; maintain a log of the process D620; and maintain internal monitoring and communication D630.

On receipt of an SMP forwarded by the telephone sub-manger of the re-direct manager system C600, the final restricted access internal communication function D610 functions similarly to the final email function D210 except that step (c) is omitted; and a final voice delivery step D518 (a) formats the message in the required formal of the private internal message system and (b) emails the reformatted SMP to the external link of the restricted access internal communication system or, via other communications channels links to the entry point for the restricted access internal communication system. The particular configuration of the receiving restricted access internal communication system will determine the selection of the hardware connection and/or the software bridge used to the Internet.

The log process D530 functions identically to log process D220.

The internal monitoring and communication component D530 functions identically to the internal monitoring and communication component D230 except that step (b) at D532 determines hourly (or other periodic basis) the size of available buffers for the entry point to the restricted access communication system.

Uses

It will be understood that the subject invention provides non-limiting advantages and uses that include faster delivery of domestic and international mail at a lower cost, (of interest to national, foreign and private postal systems, bulk mailers, print shops and fulfillment houses) delivery of letters behind a security (fire) wall (of interest to travel reservation systems and business entities with consumer loyalty programs, e.g., frequent flyer or hotel members) print shops used as postal centers (of interest to commercial printers and consumer photocopy centers), the e-mailing of messages to airline passengers and real time passenger arrival information from airlines (of interest to air travel reservation systems and businesses with consumer loyalty programs, e.g., frequent flyer or hotel members), and e-mail messages transmitted through the use of a telephone (of interest to local and regional telephone companies as well as support services for the visually impaired).

Thus, in one embodiment of the functioning of the present invention, a message sender sends an email to the central email server at an airline/airline club/hotel chain with the recipient's unique membership number in the “re-line” of the email message. The central email server would query the organizations' unique membership database for the next scheduled contact with the passenger/club member for a given number of days/hours, redirect the message via email or an internal corporate communication network to the appropriate local site, and set up a notification to the organizations “frontdesk” regarding the member's incoming message. Were the Central email server to discover that the passenger/club member was not scheduled to be in touch with the organization within the specific period, the central email server would generate an email message to the original sender stating such. Passenger/hotel guest could have the option to read the message on a monitor or have it printed.

Accordingly, the present invention transfers a message package from one communication system to another and re-directing it to an output site that shortens the time for ‘delivery’ of a message. The present invention utilizes the flexibility of SGML, XML, HTML and similar codes as well as the simplicity of electronic payments systems. The originating message can be an e-mail, a fax, a letter, a voice message, message created in a private message system (e.g. air line reservation system) or other message type. The subject invention shortens the time for delivery (and consequently the cost of the delivery) and manages the large volume of micro-payments in an efficient manner.

The Subject invention preferably includes:

The Message Preparation system

The Payment system

The Re-Direction Manager system, and

The Output system.

The Message Preparation system creates a standardized message package from any originating message system, permits the extensive use of SGML, HTML and XML formatting and messaging codes and standardizes the message to email it to the Re-Direction Manager. Routines A100 to show the process of formatting non-uniform messages into the standardized message package. The Message Preparation System includes flexible structure and format of the standardized message package; the re-definition of the use of the ‘re-line’ in the email format; the dynamic use of SGML-type code; the linkage to the Payment System; and the availability of an input wizard to ease the preparation of standardized message package and the generation of an invoice to the payment system.

The Payment system streamlines making multiple small payments, give the user multiple electronic payment choices, and handles the accounts electronically for all the individual users, input sub-operators, output sub-operators, and system operators. It also performs a number of financial administrative tasks. There are separate routines for user registration B100, costing the transformation of each message package B200, collecting payment from senders and input sub-operators B300, and settling accounts with the various input, output, and system operators B400. The Payment system includes the incorporation of the Ezpass-type payment system used on NY bridges and turnpikes and the link to internal corporate payment accounts as two of the payment options, the functioning of a pricing wizard that is adaptable to a range of individual payment components, and the dynamic generation of invoices and payment settlement arrangements between input sub-operators, output sub-operators, and the operator.

The Re-Direction Manager system ascertains the type of output communication system requested by the user and determines the best output device by matching the user's requests with the registered locations and daily capacities of the output devices staffed by output sub-operators. It also performs a number of administrative tasks. The administrative tasks handled by the re-direction manager include format checking C110, maintaining an inventory of output devices C120 and input devices C130, long term storage of the message and its delivery confirmation if requested by user C140, an internal generator of progress reports and error messages C150, a user message delivery status report function C160, and an optional multiple output of a message to more than one communication system C170. In addition, there are separate routines C200 to C600 for each message communication system that handles the initial re-formatting of the output message. The Re-Direction Manager system includes a format checking routine, a process for selecting the best output device in terms of speed of delivery and cost while being responsive to user requests and system capacities, an internal system message generator to alert message senders of any difficulties in transmitting their message, and the ability to allow message senders and sub-operator track the status of the delivery of a message.

The Output system reverses the creation of the standardized message package into the final output and maximizes the flexibility of the output using the SGML, HTML and XML codes. The administrative functions of the Output system include the dissemination of internally generated messages to senders D110 and a method of checking the financial account of the operators and sub-operators D120. In addition, there are five (D200 to D600) final output processing stages. The Output system includes the ability to take the standardized message package and re-format it for output in the new communication system in a manner that enhances the flexibility of the style of the final outcome message; and the availability of an output wizard that manages the email-output device linkage as well as the invoicing of the core operator.

The subject invention functions by combining all or part of each of these four systems, depending on specific configuration designed by the commercial operator.

What is claimed is:

1. A system for converting a message from any of transmission media selected from electronic mail, postal mail, facsimile, voice message, internal private message and computer intranet message to another, different one of said transmission media, the system comprising:
a) a component for creating a first message portion, said first message portion including instructions for transmission medium conversion from said one of said transmission media to said another, different one of said transmission media;
b) a component for creating a second message portion associated with said first message portion, said second message portion having a message body, said message body having an email attachment in computer readable code such that said message body of said second message portion is reformattable from said one of said transmission media to said another, different one of said transmission media;
c) a component for converting, if necessary, said instructions of said first message portion into computer readable code, and for converting, if necessary, said message body of said second message portion into computer readable code; and
d) a component for reformatting said message body of said second message portion from said one of said transmission media to said another, different one of said transmission media based on said instructions in said first message portion.

2. The system of claim 1 further comprising in said message XML-defined ‘mail merge’ tags and a list of addressees that together comprise a “mail merged” message package.

3. The system of claim 1 wherein said message is received by at least one of an independent site on the Internet, a series of linked sites at different points on a LAN, WAN, or internet, and an internal site on a LAN or WAN.

4. The system of claim 1 wherein said message has an addressee, said addressee identified with a unique id that is at least one of an email address, a postal address, a telephone number, a fax number, and a personal or institutional id within a private or public system, an enterprise or institution.

5. The system of claim 1 wherein:
said first message portion includes
a) user-required elements that designate parties to said message, provide a unique identifier of a message recipient, provide presentation features of said second message portion, and provide payment arrangements;
b) user-optional elements that modify presentation of the name of said recipient, modify presentation of said second message portion, support multiple mail merge features, elect document security standards and specify confirmation of delivery requirements; and
c) system-generated elements that provide unique message identifiers, provide technical specifications of an incoming message and provide technical specifications of an outgoing message; and
said second message portion utilizes computer mark-up language start-tag and end-tag markers.

6. The system of claim 1 wherein said message body of said second message portion is reformatted from said one of said transmission media to said another, different one of said transmission media based on said instructions in said first message portion, said system further comprising:
a) an email component to receive said message and to direct said message without intervention to a unique buffer for each of a plurality of said messages;
b) a browser component to open said message in said buffer; and
c) a component using a higher order (macro) language to read said first message portion of said message in said buffer and to store said instructions from said first message portion as variables, wherein said browser opens at least some email attachments in said second message portion in separate windows, said component using a higher order (macro) language passes format variables from said first message portion to software instructions that reformats said second message portion and displays in separate windows all versions of said second message portion after reformatting, and said component using a higher order (macro) language sends sequentially all of said versions of said second message portion that have been reformatted from said windows to designated output devices.

7. A method for converting a message from any of transmission media selected from electronic mail, postal mail, facsimile, voice message, internal private message and computer intranet message to another, different one of said transmission media, the method comprising:
a) creating a first message portion, said first message portion including instructions for transmission medium conversion from said one of said transmission media to said another, different one of said transmission media;
b) creating a second message portion associated with said first message portion, said second message portion having a message body, said message body having an email attachment in computer readable code such that said message body of said second message portion is reformattable from said one of said transmission media to said another, different one of said transmission media;
c) a component for converting, if necessary, said instructions of said first message portion into computer readable code, and for converting, if necessary, said message body of said second message portion into computer readable code; and
d) reformatting said message body of said second message portion from said one of said transmission media to said another, different one of said transmission media based on said instructions in said first message portion.

8. The method of claim 7 further comprising in said message XML-defined ‘mail merge’ tags and a list of addressees that together comprise a “mail merged” message package.

9. The method of claim 7 wherein said message is received by at least one of an independent site on the Internet, a series of linked sites at different points on a LAN, WAN, or internet, and an internal site on a LAN or WAN.

10. The method of claim 7 wherein said message has an addressee, said addressee identified with a unique id that is at least one of an email address, a postal address, a telephone number, a fax number, a frequent flyer number, and a personnel id number within a given enterprise or institution.

11. The method of claim 7 wherein:
said first message portion includes
d) user-required elements that designate parties to said message, provide a unique identifier of a message recipient, provide presentation features of said second message portion, and provide payment arrangements;
e) user-optional elements that modify presentation of the name of said recipient, modify presentation of said second message portion, support multiple mail merge features, elect document security standards and specify confirmation of delivery requirements; and
f) system-generated elements that provide unique message identifiers, provide technical specifications of an incoming message and provide technical specifications of an outgoing message; and
said second message portion utilizes computer mark-up language start-tag and end-tag markers.

12. The method of claim 7 wherein said message body of said second message portion is reformatted from said one of said transmission media to said another, different one of said transmission media based on said instructions in said first message portion, said method further comprising:
a) using an email component to receive said message and to direct said message without intervention to a unique buffer for each of a plurality of said messages;
b) using a browser component to open said message in said buffer; and
c) using a component using a higher order (macro) language to read said first message portion of said message in said buffer and to store said instructions from said first message portion as variables, wherein said browser opens at least some email attachments in said second message portion in separate windows, said component using a higher order (macro) language passes format variables from said first message portion to software instructions that reformats said second message portion and displays in separate windows all versions of said second message portion after reformatting, and said component using a higher order (macro) language sends sequentially all of said versions of said second message portion that have been reformatted from said windows to designated output devices.

13. In a system for converting a message from any of transmission media selected from electronic mail, postal mail, facsimile, voice message, internal private message and computer intranet message to another, different one of said transmission media, a message comprising:
a) a first message portion, said first message portion including instructions for transmission medium conversion from said one of said transmission media to said another, different one of said transmission media;
b) a second message portion associated with said first message portion, said second message portion having a message body, said message body having an email attachment in computer readable code such that said message body of said second message portion is reformattable from said one of said transmission media to said another, different one of said transmission media;
c) a component for converting, if necessary, said instructions of said first message portion into computer readable code, and for converting, if necessary, said message body of said second message portion into computer readable code; and
d) said message body of said second message portion being reformatted from said one of said transmission media to said another, different one of said transmission media based on said instructions in said first message portion.

14. The message of claim 13 further comprising in said message XML-defined ‘mail merge’ tags and a list of addressees that together comprise a “mail merged” message package.

15. The message of claim 13 wherein said message is received by at least one of an independent site on the Internet, a series of linked sites at different points on a LAN, WAN, or internet, and an internal site on a LAN or WAN.

16. The message of claim 13 wherein said message has an addressee, said addressee identified with a unique id that is at least one of an email address, a postal address, a telephone number, a fax number, a frequent flyer number, and a personnel id number within a given enterprise or institution.

17. In a system for converting a message from any of transmission media selected from electronic mail, postal mail, facsimile, voice message, internal private message and computer intranet message to another, different one of said transmission media, a financial management system comprising:
a) a component for calculating in substantially real time message transmission charges;
b) a component for generating in substantially real time invoices for at least said transmission charges;
c) a component for allocating to at least transmission operators in substantially real time respective shares of said transmission charges; and
d) a component for periodic settlement of said substantially real time invoices between different types of transmission operators.

18. The system of claim 17 wherein said real time message charges include at least one of component charges, discounts, and service charges.

19. The system of claim 17 wherein said real time message transmission charges are deducted from at least one of direct sender or recipient payment accounts, pre-payment trust accounts, pre-authorized credit card and debt accounts, internal corporate accounting systems, and supplemental charges on existing non-postal system billing procedures.

20. In a method for converting a message from any of transmission media selected from electronic mail, postal mail, facsimile, voice message, internal private message and computer intranet message to another, different one of said transmission media, a financial management method comprising:
a) calculating in substantially real time message transmission charges;
b) generating in substantially real time invoices for at least said transmission charges; and
c) allocating to at least transmission operators in substantially real time respective shares of said transmission charges.

21. The method of claim 20 wherein said real time message charges include at least one of component charges, discounts, and service charges.

22. The method of claim 20 wherein said real time message transmission charges are deducted from at least one of direct sender or recipient payment accounts, pre-payment trust accounts, pre-authorized credit card and debt accounts, internal corporate accounting systems, and supplemental charges on existing non-postal system billing procedures.

23. In a system for converting a message from any of transmission media selected from electronic mail, postal mail, facsimile, voice message, internal private message and computer intranet message to another, different one of said transmission media, an invoice comprising:
a) substantially real time message transmission charges; and
b) an allocation to at least transmission operators in substantially real time respective shares of said transmission charges.

24. In a system for converting a message from any of transmission media selected from electronic mail, postal mail, facsimile, voice message, internal private message and computer intranet message to another, different one of said transmission media, a re-direction system comprising:
a) a database of message output centers populated with data of at least one of the location, type of output and output capacity of a plurality of message output centers;
b) a component for parsing data in a message to be transmitted to one of said plurality of message output centers;
c) a component for matching said message with one of said plurality of message output centers based on matching of said data of said message with said data of said plurality of message output centers, and for selecting a message output center for transmission of said message based on said matching of said data of said message with said data of said plurality of message output centers.

25. The system of claim 24 wherein said type of output of said database of message output centers includes at least one of telephone number format, fax number format and private message system format.

26. The system of claim 24 further comprising providing a database of message input device centers populated with data of at least one of the location, type of input and input capacity of a plurality of message input centers.

27. The system of claim 24 wherein the information on a subject-line and any xml and html output specific information of said message is used to determine the best output center from said database of message output centers, and then a cover portion of said message package is reformatted with the email address of said best output center.

28. In a method for converting a message from any of transmission media selected from electronic mail, postal mail, facsimile, voice message, internal private message and computer intranet message to another, different one of said transmission media, a re-direction method comprising:
a) providing a database of message output centers populated with data of at least one of the location, type of output and output capacity of a plurality of message output centers;
b) providing a component for parsing data in a message to be transmitted to one of said plurality of message output centers;
c) providing a component for matching said message with one of said plurality of message output centers based on matching of said data of said message with said data of said plurality of message output centers, and for selecting a message output center for transmission of said message based on said matching of said data of said message with said data of said plurality of message output centers.

29. The method of claim 28 wherein said type of output of said database of message output centers includes at least one of telephone number format, fax number format and private message system format.

30. The method of claim 28 further comprising providing a database of message input device centers populated with data of at least one of the location, type of input and input capacity of a plurality of message input centers.

31. The method of claim 28 wherein the information on a message subject-line and any xml and html output specific information of said message is used to determine the best output center from said database of message output centers, and then a cover portion of said message package is reformatted with the email address of said best output center.

32. In a system for converting a message from any of transmission media selected from electronic mail, postal mail, internal private message and computer intranet message to another, different one of said transmission media, a re-direction system comprising:
a) a database of user identification indicia, said user identification indicia including different identification indicia for a user during use of at least said one of said transmission media and use of said another, different one of said transmission media;
b) a database of message medium options cross-referenced with said database of user identification indicia whereby message medium of said message is changeable from said one of said transmission media to said another, different one of said transmission media based on said different identification indicia for said user.

33. The system of claim 32 wherein a message output center outputs said message using an output device and functionality of said message output center is checked by:
querying via email the status of each output device at said message output center on a periodic basis;
receiving an automatically generated reply from said message output center; and
on the basis of said automatically generated reply, updating a database with information gathered, including error messages.

34. In a method for converting a message from any of transmission media selected from electronic mail, postal mail, internal private message and computer intranet message to another, different one of said transmission media, a re-direction method comprising:
a) providing a database of user identification indicia, said user identification indicia including different identification indicia for a user during use of at least said one of said transmission media and use of said another, different one of said transmission media; and
b) providing a database of message medium options cross-referenced with said database of user identification indicia whereby message medium of said message is changeable from said one of said transmission media to said another, different one of said transmission media based on said different identification indicia for said user.

35. The method of claim 34 wherein a message output center outputs said message using an output device and functionality of said message output center is checked by:
querying via email the status of each local output device at said message output center on a periodic basis;
receiving an automatically generated reply from said message output center; and
on the basis of said automatically generated reply, updating a database with information gathered, including error messages.

36. A system for converting a message from any of transmission media selected from electronic mail, postal mail, facsimile, voice message, internal private message and computer intranet message to another, different one of said transmission media, the system comprising:
a conversion system having:
a) a component for creating a first message portion, said first message portion including instructions for transmission medium conversion from said one of said transmission media to said another, different one of said transmission media;
b) a component for creating a second message portion associated with said first message portion, said second message portion having a message body, said message body having an email attachment in computer readable code such that said message body of said second message portion is reformattable from said one of said transmission media to said another, different one of said transmission media;
c) a component for converting, if necessary, said instructions of said first message portion into computer readable code, and for converting, if necessary, said message body of said second message portion into computer readable code; and
d) a component for reformatting said message body of said second message portion from said one of said transmission media to said another, different one of said transmission media based on said instructions in said first message portion;
a financial management system having:
a) a component for calculating in substantially real time message transmission charges;
b) a component for generating in substantially real time invoices for at least said transmission charges; and
c) a component for allocating to at least transmission operators in substantially real time respective shares of said transmission charges; and
a re-direction system having:
a) a database of message output centers populated with data of at least one of the location, type of output and output capacity of a plurality of message output centers;
b) a component for parsing data in a message to be transmitted to one of said plurality of message output centers;
c) a component for matching said message with one of said plurality of message output centers based on matching of said data of said message with said data of said plurality of message output centers, and for selecting a message output center for transmission of said message based on said matching of said data of said message with said data of said plurality of message output centers;
d) a database of user identification indicia, said user identification indicia including different identification indicia for a user during use of at least said one of said transmission media and use of said another, different one of said transmission media; and
e) a data base of message medium options cross-referenced with said database of user identification indicia whereby message medium of said message is changeable from said one of said transmission media to said another, different one of said transmission media based on said different identification indicia for said user.

37. The system of claim 36 further comprising in said message XML-defined ‘mail merge’ tags and a list of addressees that together comprise a “mail merged” message package.

38. The system of claim 36 wherein said message is received by at least one of an independent site on the Internet, a series of linked sites at different points on a LAN, WAN, or internet, and an internal site on a LAN or WAN.

39. The system of claim 36 wherein said message has an addressee, said addressee identified with a unique id that is at least one of an email address, a postal address, a telephone number, a fax number, a frequent flyer number, and a personnel id number within a given enterprise or institution.

40. The system of claim 36 wherein said real time message charges include at least one of component charges, discounts, and service charges.

41. The system of claim 36 wherein said real time message transmission charges are deducted from at least one of direct sender or recipient payment accounts, pre-payment trust accounts, pre-authorized credit card and debt accounts, internal corporate accounting systems, and supplemental charges on existing non-postal system billing procedures.

42. The system of claim 36 wherein said type of output of said database of message output centers includes at least one of telephone number format, fax number format and private message system format.

43. The system of claim 36 further comprising providing a database of message input device centers populated with data of at least one of the location, type of input and input capacity of a plurality of message input centers.

44. The system of claim 36 wherein the information on a message subject-line and any xml and html output specific information of said message is used to determine the best output center from said database of message output centers, and then a cover portion of said message package is reformatted with the email address of said best output center.

45. The system of claim 36 wherein a message output center outputs said message using an output device and functionality of said message output center is checked by:
querying via email the status of each local output device at said message output center on a periodic basis;
receiving an automatically generated reply from said message output center; and
on the basis of said automatically generated reply, updating a database with information gathered, including error messages.

46. The system of claim 36 wherein:
said first message portion includes
g) user-required elements that designate parties to said message, provide a unique identifier of a message recipient, provide presentation features of said second message portion, and provide payment arrangements;
h) user-optional elements that modify presentation of the name of said recipient, modify presentation of said second message portion, support multiple mail merge features, elect document security standards and specify confirmation of delivery requirements; and
i) system-generated elements that provide unique message identifiers, provide technical specifications of an incoming message and provide technical specifications of an outgoing message; and
said second message portion utilizes computer mark-up language start-tag and end-tag markers.

47. The system of claim 36 wherein said message body of said second message portion is reformatted from said one of said transmission media to said another, different one of said transmission media based on said instructions in said first message portion, said system further comprising:
a) an email component to receive said message and to direct said message without intervention to a unique buffer for each of a plurality of said messages;
b) a browser component to open said message in said buffer; and
c) a component using a higher order (macro) language to read said first message portion of said message in said buffer and to store said instructions from said first message portion as variables, wherein said browser opens at least some email attachments in said second message portion in separate windows, said component using a higher order (macro) language passes format variables from said first message portion to software instructions that reformats said second message portion and displays in separate windows all versions of said second message portion after reformatting, and said component using a higher order (macro) language sends sequentially all of said versions of said second message portion that have been reformatted from said windows to designated output devices.

48. A method for converting a message from any of transmission media selected from electronic mail, postal mail, facsimile, voice message, internal private message and computer intranet message to another, different one of said transmission media, the method comprising:
using a conversion system by:
a) creating a first message portion, said first message portion including instructions for transmission medium conversion from said one of said transmission media to said another, different one of said transmission media;
b) creating a second message portion associated with said first message portion, said second message portion having a message body, said message body having an email attachment in computer readable code such that said message body of said second message portion is reformattable from said one of said transmission media to said another, different one of said transmission media;
c) converting, if necessary, said instructions of said first message portion into computer readable code, and for converting, if necessary, said message body of said second message portion into computer readable code; and
d) reformatting said message body of said second message portion from said one of said transmission media to said another, different one of said transmission media based on said instructions in said first message portion;
using a financial management by:
a) calculating in substantially real time message transmission charges;
b) generating in substantially real time invoices for at least said transmission charges; and
c) allocating to at least transmission operators in substantially real time respective shares of said transmission charges; and
using a re-direction system by:
a) using a database of message output centers populated with data of at least one of the location, type of output and output capacity of a plurality of message output centers;
b) using a component for parsing data in a message to be transmitted to one of said plurality of message output centers;
c) using a component for matching said message with one of said plurality of message output centers based on matching of said data of said message with said data of said plurality of message output centers, and for selecting a message output center for transmission of said message based on said matching of said data of said message with said data of said plurality of message output centers;
d) using a database of user identification indicia, said user identification indicia including different identification indicia for a user during use of at least said one of said transmission media and use of said another, different one of said transmission media; and
e) using a data base of message medium options cross-referenced with said database of user identification indicia whereby message medium of said message is changeable from said one of said transmission media to said another, different one of said transmission media based on said different identification indicia for said user.

49. The method of claim 48 further comprising in said message XML-defined ‘mail merge’ tags and a list of addressees that together comprise a “mail merged” message package.

50. The method of claim 48 wherein said message is received by at least one of an independent site on the Internet, a series of linked sites at different points on a LAN, WAN, or internet, and an internal site on a LAN or WAN.

51. The method of claim 48 wherein said message has an addressee, said addressee identified with a unique id that is at least one of an email address, a postal address, a telephone number, a fax number, a frequent flyer number, and a personnel id number within a given enterprise or institution.

52. The method of claim 48 wherein said real time message charges include at least one of component charges, discounts, and service charges.

53. The method of claim 48 wherein said real time message transmission charges are deducted from at least one of direct sender or recipient payment accounts, pre-payment trust accounts, pre-authorized credit card and debt accounts, internal corporate accounting systems, and supplemental charges on existing non-postal system billing procedures.

54. The method of claim 48 wherein said type of output of said database of message output centers includes at least one of telephone number format, fax number format and private message system format.

55. The method of claim 48 further comprising providing a database of message input device centers populated with data of at least one of the location, type of input and input capacity of a plurality of message input centers.

56. The method of claim 48 wherein the information on a message subject-line and any xml and html output specific information of said message is used to determine the best output center from said database of message output centers, and then a cover portion of said message package is reformatted with the email address of said best output center.

57. The method of claim 48 wherein a message output center outputs said message using an output device and functionality of said message output center is checked by:
querying via email the status of each local output device at said message output center on a periodic basis;
receiving an automatically generated reply from said message output center; and
on the basis of said automatically generated reply, updating a database with information gathered, including error messages.

58. The method of claim 48 wherein:
said first message portion includes
j) user-required elements that designate parties to said message, provide a unique identifier of a message recipient, provide presentation features of said second message portion, and provide payment arrangements;
k) user-optional elements that modify presentation of the name of said recipient, modify presentation of said second message portion, support multiple mail merge features, elect document security standards and specify confirmation of delivery requirements; and
l) system-generated elements that provide unique message identifiers, provide technical specifications of an incoming message and provide technical specifications of an outgoing message; and
said second message portion utilizes computer mark-up language start-tag and end-tag markers.

59. The method of claim 48 wherein said message body of said second message portion is reformatted from said one of said transmission media to said another, different one of said transmission media based on said instructions in said first message portion, said method further comprising:
a) using an email component to receive said message and to direct said message without intervention to a unique buffer for each of a plurality of said messages;
b) using a browser component to open said message in said buffer; and
c) using a component using a higher order (macro) language to read said first message portion of said message in said buffer and to store said instructions from said first message portion as variables, wherein said browser opens at least some email attachments in said second message portion in separate windows, said component using a higher order (macro) language passes format variables from said first message portion to software instructions that reformats said second message portion and displays in separate windows all versions of said second message portion after reformatting, and said component using a higher order (macro) language sends sequentially all of said versions of said second message portion that have been reformatted from said windows to designated output devices.
